(19) United States
(12) Patent Application Publication
(10) Pub. No.: US 2022/0256566 A1
(43) Pub. Date: Aug. 11, 2022

(54) INDICATION OF REPETITION NUMBER FOR PHYSICAL SHARED CHANNEL

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/629,665

(22) PCT Filed: Jul. 25, 2019
(86) PCT No.: PCT/CN2019/097767

§ 371 Date: Jan. 24, 2022

(51) Int. Cl. H04W 72/12; H04L 5/00; H04L 1/08

(52) U.S. Cl. CPC H04W 72/1263; H04L 1/08; H04L 5/0051; H04W 72/1289

(57) ABSTRACT

Embodiments of the present disclosure relate to methods, devices and computer readable media for indication of a repetition number for a physical shared channel. A method comprises receiving, from a network device, DCI for scheduling communications over a physical shared channel; in response to receiving an indication of whether repetitions of the physical shared channel are enabled or disabled, selecting a DMRS table from a plurality of predefined DMRS tables; in response to the repetitions of the physical shared channel being disabled, determining, based on the DCI and the DMRS table, a first configuration for DMRS communication over the physical shared channel; and in response to the repetitions of the physical shared channel being enabled, determining, based on the DCI and the DMRS table, the number of the repetitions and a second configuration for DMRS communication over the repetitions of the physical shared channel.

### TECHNICAL FIELD

Embodiments of the present disclosure generally relate to the field of telecommunication, and in particular, to methods, devices and computer storage media for indication of a repetition number for a physical shared channel.

### BACKGROUND

In New Radio access (NR), a network device (for example, a next generation NodeB (gNB)) may be equipped with multiple Transmission and Reception Points (TRPs) or antenna panels. That is, the network device can communicate with a terminal device (for example, a user equipment (UE)) via one or more of the multiple TRPs or antenna panels, which is also referred to as “multi-TRP communication”.

In some Multi-TRP communication schemes, single downlink control information (DCI) can be used to schedule a number of Physical Downlink Shared Channel (PDSCH) or Physical Uplink Shared Channel (PUSCH) repetitions to achieve better performance. Switching between different repetition numbers can cater for different service requirements and/or different propagation environments. Therefore, it is desirable to support dynamic indication of the repetition number with reduced overhead.

### SUMMARY

In general, example embodiments of the present disclosure provide methods, devices and computer storage media for indication of a repetition number for a physical shared channel.

In a first aspect, there is provided a method of communication. The method comprises: receiving, at a terminal device and from a network device, Downlink Control Information (DCI) for scheduling communications over a physical shared channel; in response to receiving an indication of whether repetitions of the physical shared channel are enabled or disabled, selecting, based on the indication, a Demodulation Reference Signal (DMRS) table from a plurality of predefined DMRS tables; in response to the repetitions of the physical shared channel being disabled, determining, based on the DCI and the DMRS table, a first configuration for DMRS communication over the physical shared channel; and in response to the repetitions of the physical shared channel being enabled, determining, based on the DCI and the DMRS table, the number of the repetitions and a second configuration for DMRS communication over the repetitions of the physical shared channel.

In a second aspect, there is provided a method of communication. The method comprises: transmitting, from a network device to a terminal device, an indication of whether repetitions of a physical shared channel are enabled or disabled; selecting, based on the indication, a DMRS table from a plurality of predefined DMRS tables; generating, based on the DMRS table, Downlink Control Information (DCI) for scheduling communications over the physical shared channel, wherein in response to the repetitions of the physical shared channel being disabled, the DCI indicates a first configuration for DMRS communication over the physical shared channel, and in response to the repetitions of the physical shared channel being enabled, the DCI indicates the number of the repetitions and a second configuration for DMRS communication over the repetitions of the physical shared channel; and transmitting the DCI to the terminal device.

In a third aspect, there is provided a terminal device. The terminal device comprises a processor and a memory. The memory is coupled to the processor and stores instructions thereon. The instructions, when executed by the processor, cause the terminal device to perform actions comprising: receiving, from a network device, Downlink Control Information (DCI) for scheduling communications over a physical shared channel; in response to receiving an indication of whether repetitions of the physical shared channel are enabled or disabled, selecting, based on the indication, a Demodulation Reference Signal (DMRS) table from a plurality of predefined DMRS tables; in response to the repetitions of the physical shared channel being disabled, determining, based on the DCI and the DMRS table, a first configuration for DMRS communication over the physical shared channel; and in response to the repetitions of the physical shared channel being enabled, determining, based on the DCI and the DMRS table, the number of the repetitions and a second configuration for DMRS communication over the repetitions of the physical shared channel.

In a fourth aspect, there is provided a network device. The network device comprises a processor and a memory. The memory is coupled to the processor and stores instructions thereon. The instructions, when executed by the processor, cause the network device to perform actions comprising: transmitting, to a terminal device, an indication of whether repetitions of a physical shared channel are enabled or disabled; selecting, based on the indication, a DMRS table from a plurality of predefined DMRS tables; generating, based on the DMRS table, Downlink Control Information (DCI) for scheduling communications over the physical shared channel, wherein in response to the repetitions of the physical shared channel being disabled, the DCI indicates a first configuration for DMRS communication over the physical shared channel, and in response to the repetitions of the physical shared channel being enabled, the DCI indicates the number of the repetitions and a second configuration for DMRS communication over the repetitions of the physical shared channel; and transmitting the DCI to the terminal device.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates an example signaling chart showing an example process in accordance with some embodiments of the present disclosure;

FIGS. 3A-3C illustrate example diagrams of some embodiments of the present disclosure;

FIG. 4 illustrates an example method in accordance with some embodiments of the present disclosure;

FIG. 5 illustrates an example method in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

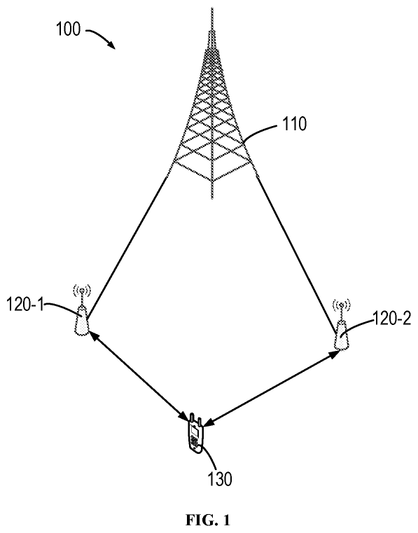

FIG. 1 illustrates an example communication network 100 in which embodiments of the present disclosure can be implemented. As shown in FIG. 1, the network 100 includes a network device 110, which is coupled with two TRPs/panels 120-1 and 120-2 (collectively referred to as TRPs 120 or individually referred to as TRP 120). The network 100 also includes a terminal device 130 served by the network device 110. It is to be understood that the number of network devices, terminal devices and TRPs as shown in FIG. 1 is only for the purpose of illustration without suggesting any limitations to the present disclosure. The network 200 may include any suitable number of devices adapted for implementing embodiments of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 130.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via Radio Resource Control (RRC) signaling.

As shown in FIG. 1, the network device 110 may communicate with the terminal device 130 via the TRPs 120-1 and 120-2. In the following text, the TRP 120-1 may be also referred to as the first TRP, while the TRP 120-2 may be also referred to as the second TRP. Each of the TRPs 120 may provide a plurality of beams for communication with the terminal device 130.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In addition to normal data communications, the network device 110 may transmit reference signals (RS) in broadcast, multi-cast, and/or unicast manners to the terminal device 130 in a downlink (such as, via the TRP 120-1 or 120-2). Similarly, the terminal devices 130 may transmit RSs to the network device 110 in an uplink (such as, via the TRP 120-1 or 120-2). As used herein, a “downlink (DL)” refers to a link from a network device to a terminal device, while an “uplink (UL)” refers to a link from the terminal device to the network device. Examples of the RS may include but are not limited to downlink or uplink Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on. DMRS may be a type of RSs that provides modulation/demodulation information related to a communication channel for accurate or coherent decoding of information transmitted via the communication channel.

Prior to the UL or DL DMRS transmission, the network device 110 may allocate corresponding ports (also referred to as “DMRS ports”) for DMRS transmission and/or specify which DMRS sequence is to be transmitted. As used herein, a DMRS port may refer to a specific mapping of part or all of a DMRS sequence to one or more resource elements (REs) of a resource region allocated for DMRS transmission in time, frequency, and/or code domains. In NR, different DMRS ports may be multiplexed based on Code Division Multiplexing (CDM) technology in time and/or frequency domain, and/or based on Frequency Division Multiplexing (FDM) technology. For example, a group of DMRS ports may also referred to as a “DMRS port group” or “DMRS group”. A group of DMRS ports multiplexed based on CDM technology can also be referred as a “CDM group”.

In some embodiments, such resource allocation information as well as other necessary information may be indicated to the terminal device 130 prior to the DMRS transmission. For example, the DMRS configuration can be transmitted via higher layer signaling (such as, Radio Resource Control (RRC) signaling and/or Medium Access Control (MAC) layer signaling) and/or dynamic signaling (such as, downlink control information (DCI)) to the terminal device 130.

In some embodiments, a number of codewords (CWs) may be configured to the terminal device 130. For example, the number may be 1 or 2. For example, the number of CWs may be configured via RRC signaling, MAC layer signaling and/or Physical Layer (PHY) signaling.

In some embodiments, a set of parameters for DMRS communication may be configured to the terminal device 130. The set of parameters may include at least one of the maximum number/length of the symbols for DMRS, a type of DMRS, and etc. For example, the set of parameters may be configured via RRC signaling, MAC layer signaling and/or Physical Layer (PHY) signaling.

In some embodiments, the maximum number/length (for example, the maximum number/length is M) of symbols for DMRS may be the maximum number of symbols for each DMRS transmission occasion in one PDSCH transmission duration, and one DMRS transmission occasion may comprise K consecutive symbols. For example, M may be 1, 2, 3 or 4. For example, K may be 1, 2, 3 or 4, and K may not exceed M. In some embodiments, the maximum number/length (for example, the maximum number/length is M) of symbols for DMRS may equal to the maximum number of symbols for the front-loaded DMRS, where the front-loaded DMRS is the first DMRS transmission occasion in the K consecutive symbols of one PDSCH transmission duration.

In some embodiments, the type of DMRS may be the DMRS configuration pattern in time and/or frequency domain. There are up to two types of DMRS that can be configured to a terminal device (for example, DMRS type 1 and/or DMRS type 2). In some embodiments, DMRS type 1 can include up to 8 DMRS ports (for example, when the maximum number/length of DMRS is 2). The DMRS ports are multiplexed based on at least one of Frequency Division Multiplexing (FDM), Code Division Multiplexing (CDM) in time domain and CDM in frequency domain. In some embodiments, DMRS type 1 can include up to 4 DMRS ports (for example, when the maximum number/length of DMRS is 1). The DMRS ports are multiplexed based on at least one of FDM and CDM in frequency domain.

In some embodiments, DMRS type 2 can include up to 12 DMRS ports (for example, when the maximum number/length of DMRS is 2). The DMRS ports are multiplexed with at least one of FDM (frequency domain multiplexing), CDM (code domain multiplexing) in frequency domain and CDM in time domain. In some embodiments, DMRS type 2 can include up to 6 DMRS ports (for example, when the maximum number/length of DMRS is 1). The DMRS ports are multiplexed with at least one of FDM and CDM in frequency domain.

In some embodiments, if DMRS ports are multiplexed only based on CDM in time and/or frequency domain, the DMRS ports are QCLed with each other with respect to {Doppler shift, Doppler spread, average delay, average spread, Spatial Rx parameter} and/or average gain. Alternatively, the DMRS ports are QCLed with each with respect to QCL-TypeA and QCL-TypeD and/or average gain.

In some embodiments, the DMRS ports within different DMRS groups can be multiplexed with FDM and/or Time Domain Multiplexing (TDM). In some embodiments, for DMRS type 1, the maximum 8 DMRS ports may be {0,1,2,3,4,5,6,7}. DMRS ports {0,1,4,5} are multiplexed with CDM in frequency domain and/or CDM in time domain, DMRS ports {0,1,4,5} should be QCLed with each other with respect to {Doppler shift, Doppler spread, average delay, average spread, Spatial Rx parameter} and/or average gain, and DMRS ports {0,1,4,5} should be within one DMRS group. DMRS ports {2,3,6,7} are multiplexed with CDM in frequency domain and/or CDM in time domain, DMRS ports {2,3,6,7} should be QCLed with each other with respect to {Doppler shift, Doppler spread, average delay, average spread, Spatial Rx parameter} and/or average gain, and DMRS ports {2,3,6,7} should be within one DMRS group.

In some embodiments, as an example of grouping of the DMRS ports, for DMRS type 1 as defined in 3GPP specifications, up to 2 DMRS groups (DMRS group G1 and/or DMRS group G2) may be configured. For example, if two DMRS groups are configured, DMRS group G1 may include at least one DMRS port from DMRS ports {0,1,4,5}, and DMRS group G2 may include at least one DMRS port from DMRS ports {2,3,6,7}. As another example, if only one DMRS group is configured, there is only one DMRS group G1 or DMRS group G2, and DMRS group G1 or DMRS group G2 may include at least one DMRS port from {0,1,2,3,4,5,6,7}.

In some embodiments, the DMRS ports within different DMRS groups can be multiplexed with FDM and/or TDM. In some embodiments, for DMRS type 2, the maximum 12 DMRS ports may be represented as DMRS ports {0,1,2,3,4,5,6,7,8,9,10,11}. DMRS ports {0,1,6,7} are multiplexed with CDM in frequency domain and/or CDM in time domain, DMRS ports {0,1,6,7} should be QCLed with each other with respect to {Doppler shift, Doppler spread, average delay, average spread, Spatial Rx parameter} and/or average gain, and DMRS ports {0,1,6,7} should be within one DMRS group. DMRS ports {2,3,8,9} are multiplexed with CDM in frequency domain and/or CDM in time domain, DMRS ports {2,3,8,9} should be QCLed with each other with respect to {Doppler shift, Doppler spread, average delay, average spread, Spatial Rx parameter} and/or average gain, and DMRS ports {2,3,8,9} should be within one DMRS group. DMRS ports {4,5,10,11} are multiplexed with CDM in frequency domain and/or CDM in time domain, DMRS ports {4,5,10,11} should be QCLed with each other with respect to {Doppler shift, Doppler spread, average delay, average spread, Spatial Rx parameter} and/or average gain, and DMRS ports {4,5,10,11} should be within one DMRS group.

In some embodiments, as an example of grouping of the DMRS ports, for DMRS type 2 as defined in 3GPP specifications, up to 2 DMRS groups (DMRS group G1 and/or DMRS group G2) may be configured. For example, if two DMRS groups are configured, DMRS group G1 may include at least one DMRS port from DMRS ports {0,1,6,7, 4,5,10,11}, and DMRS group G2 may include at least one DMRS port from DMRS ports {2,3,8,9}. As another example, if two DMRS groups are configured, DMRS group G1 may include at least one DMRS port from DMRS ports {0,1,6,7}, and DMRS group G2 may include at least one DMRS port from DMRS ports {2,3,8,9,4,5,10,11}. As another example, if two DMRS groups are configured, DMRS group G1 may include at least one DMRS port from DMRS ports {0,1,6,7,2,3,8,9}, and DMRS group G2 may include at least one DMRS port from DMRS ports {4,5,10,11}. As another example, if only one DMRS group is configured, there is only one DMRS group G1 or DMRS group G2, and DMRS group G1 or DMRS group G2 may include at least one DMRS port from DMRS ports {0,1,2,3,4,5,6,7,8,9,10,11}.

In some embodiments, as an example of grouping of the DMRS ports, for DMRS type 2 as defined in 3GPP specifications, three DMRS groups (DMRS group G1, DMRS group G2, and DMRS group G3) may be configured. For example, if three DMRS groups are configured, DMRS group G1 may include at least one DMRS port from DMRS ports {0,1,6,7}, DMRS group G2 may include at least one DMRS port from DMRS ports {2,3,8,9}, and DMRS group G3 may include at least one DMRS port from DMRS ports {4,5,10,11}.

In current specifications, there may be a transmission control indication (TCI) field in DCI. For example, the TCI field may include 3 or 4 bits, and a value of the TCI field may be referred to as a “TCI codepoint”. A TCI codepoint may indicate one or more TCI states. A TCI state may indicate one RS set and parameters for configuring QCL relationship between one or two RSs within the RS set and the DMRS ports of the PDSCH. The terminal device 130 may also be configured with a DMRS type, a maximum number/length of DMRS and/or the number of CWs. If the terminal device 130 is configured with a given DMRS type, a given value of the maximum number/length of DMRS, and a given value of the number of CWs, there may be one corresponding DMRS table for indication of at least one of DMRS ports, the number of DMRS CDM group(s) without data, the number of front-loaded DMRS symbols, the number of DMRS ports, and the indices for the DMRS ports.

As described above, in some Multi-TRP communication schemes, single DCI can be used to schedule a number of PDSCH or PUSCH repetitions to achieve better performance. Switching between different repetition numbers can cater for different service requirements and/or different propagation environments. Therefore, it is desirable to support dynamic indication of the repetition number with reduced overhead.

Example embodiments of the present disclosure provide a solution for indicating a repetition number of a physical shared channel. This solution proposes different DMRS tables for indicating the DMRS configuration in repetition and non-repetition scenarios. For the non-repetition scenario, the legacy DMRS table can be utilized. For the repetition scenario, a new DMRS table can be designed. The number of repetitions of the physical channel can be indicated by an additional field in the DCI or implicitly indicated by a DMRS configuration from the new DMRS table. As such, dynamic indication of the repetition number can be supported, without increasing the indication overhead in the DCI.

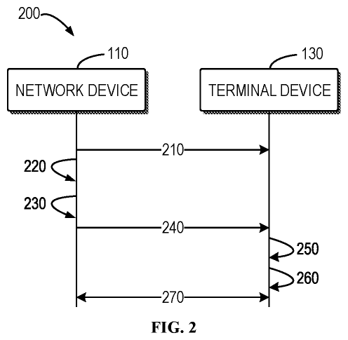

FIG. 2 illustrates an example signaling chart showing an example process 200 in accordance with some embodiments of the present disclosure. As shown in FIG. 2, the process 200 may involve the network device 110 and the terminal device 130 as shown in FIG. 1. It is to be understood that the process 200 may include additional acts not shown and/or may omit some acts as shown, and the scope of the present disclosure is not limited in this regard.

As shown in FIG. 2, the network device 110 may transmit 210, to the terminal device 130, an indication of whether repetitions of a physical shared channel are enabled or not. In some embodiments, the physical shared channel may be a PUSCH or a PDSCH. In the following, some embodiments will be described with reference to PDSCH as an example of the physical shared channel. It is to be understood that this is merely for the purpose of illustration, without suggesting any limitation to the scope of the present disclosure.

In some embodiments, the indication may be transmitted from the network device 110 to the terminal device 130 via any of the following: Radio Resource Control (RRC) signaling, Media Access Control (MAC) layer signaling, or DCI. For example, one bit or one parameter can be used to indicate whether repetitions of the physical shared channel are enabled or disabled. If the indication is transmitted from the network device 110 to the terminal device 130 via DCI, dynamic switching between the repetition scenario and the non-repetition scenario can be supported.

As shown in FIG. 2, the network device 110 may select 220, based on the indication, a DMRS table from a plurality of predefined DMRS tables. The selected DMRS table may be used for indicating a DMRS configuration and/or the number of repetitions of the physical shared channel. The network device 110 may generate 230, based on the selected DMRS table, DCI for scheduling communications over the physical shared channel. In some embodiments, in response to the repetitions of the physical shared channel being disabled, the generated DCI may indicate a configuration (also referred to as “first configuration” in the following) for DMRS communication over the physical shared channel. In some embodiments, in response to the repetitions of the physical shared channel being enabled, the generated DCI may indicate both the number of repetitions and a configuration (also referred to as “second configuration” in the following) for DMRS communication over the repetitions of the physical shared channel. The network device 110 may transmit 240 the generated DCI to the terminal device 130.

In response to receiving the indication and the DCI from the network device 110, the terminal device 130 may select 250, based on the indication and/or the DCI, a DMRS table from a plurality of predefined DMRS tables. In response to the indication indicates that the repetitions of the physical shared channel are disabled, the terminal device 130 may determine 260, based on the DCI and the DMRS table, the first configuration for DMRS communication over the physical shared channel. In response to the indication indicates that the repetitions of the physical shared channel are enabled, the terminal device 130 may determine 260, based on the DCI and the DMRS table, the number of the repetitions and a second configuration for DMRS communication over the repetitions of the physical shared channel.

Then, as shown in FIG. 2, the network device 110 and the terminal device 130 may conduct 270 communications over the physical shared channel. For example, in PUSCH communications, if the repetitions of the PUSCH are disabled, the terminal device 130 may transmit, based on the first configuration, a DMRS to the network device 110 over the PUSCH. If the repetitions of the PUSCH are enabled, the terminal device 130 may transmit, based on the second configuration, at least one DMRS to the network device 110 over the repetitions of the PUSCH. For example, in PDSCH communications, if the repetitions of the PDSCH are disabled, the network device 110 may transmit, based on the first configuration, a DMRS to the terminal device 130 over the PDSCH. If the repetitions of the PDSCH are enabled, the network device 110 may transmit, based on the second configuration, at least one DMRS to the terminal device 130 over the repetitions of the PDSCH.

In some embodiments, a plurality of DMRS tables used for indication of different DMRS configurations may be specified or predefined at the network device 110 and/or the terminal device 130. A DMRS table may comprise a plurality of configurations for DMRS communication between the network device 110 and the terminal device 130 over the physical shared channel (such as, PDSCH or PUSCH). Each configuration (also referred to as “DMRS configuration”) in the DMRS table may indicate at least one of DMRS ports, the number of DMRS CDM groups without data, the number of front-loaded DMRS symbols, the number of DMRS ports, and the indices for the DMRS ports. Typically, if a given DMRS type, a given value of the maximum number/length of DMRS, and a given value of the number of CWs are configured, a corresponding DMRS table can be determined for indicating a DMRS configuration.

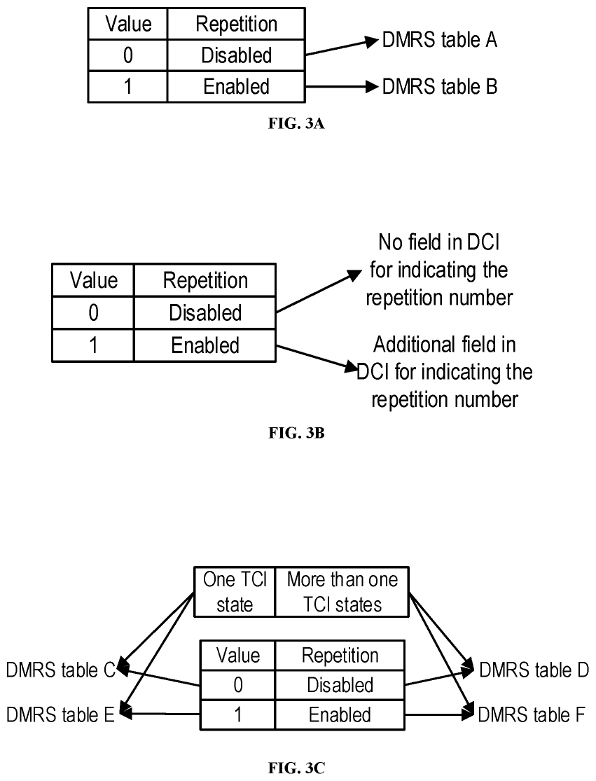

In some embodiments, the plurality of predefined DMRS tables may include at least a first DMRS table (also referred to as “DMRS table A” in the following) and a second DMRS table (also referred to as “DMRS table B” in the following). DMRS table A may be different from DMRS table B. In some embodiments, if the indication indicates that the repetitions of the physical shared channel are disabled, DMRS table A (that is, the first DMRS table) can be selected; and if the indication indicates that the repetitions of the physical shared channel are enabled, DMRS table B (that is, the second DMRS table) can be selected. FIG. 3A illustrates an example of such embodiments. As shown in FIG. 3A, if the indication is ‘0’, which means that the repetitions of the physical shared channel are disabled, DMRS table A can be selected; and if the indication is ‘1’, which means that the repetitions of the physical shared channel are enabled, DMRS table B can be selected.

In some embodiments, DMRS table A may be different from DMRS table B in at least one of the following: the number of available DMRS ports; the number of available front-loaded symbols for DMRS; the number of available DMRS CDM groups; and the number of available CWs.

In some embodiments, for DMRS type 1 and if the maximum number of OFDM symbols for front-loaded DMRS or the maximum length of DMRS is 1, the number of available DMRS ports in DMRS table A may be 1, 2, 3 or 4. In some embodiments, for DMRS type 1 and if the maximum number of OFDM symbols for front-loaded DMRS or the maximum length of DMRS is 2, the number of available DMRS ports in DMRS table A may be 1, 2, 3, 4, 5, 6, 7 or 8. In some embodiments, for DMRS type 2 and if the maximum number of OFDM symbols for front-loaded DMRS or the maximum length of DMRS is 1, the number of available DMRS ports in DMRS table A may be 1, 2, 3, 4, 5 or 6. In some embodiments, for DMRS type 2 and if the maximum number of OFDM symbols for front-loaded DMRS or the maximum length of DMRS is 2, the number of available DMRS ports in DMRS table A may be 1, 2, 3, 4, 5, 6, 7 or 8. In some embodiments, the number of available DMRS ports in DMRS table B may be 1 or 2. In some embodiments, there may be no DMRS table B, or alternatively, there may be no bit/field in DCI to indicate DMRS table B. For example, in this case, the number of DMRS ports may be assumed to be 1. For another example, in this case, the DMRS port may be assumed to be DMRS port 0.

In some embodiments, for DMRS type 1, the number of available DMRS CDM group(s) without data in DMRS table A may be 1 or 2. In some embodiments, for DMRS type 1, the number of available DMRS CDM group(s) without data in DMRS table B may be only 1. In some embodiments, for DMRS type 1, the number of available DMRS CDM group(s) without data in DMRS table B may be only 2. In some embodiments, for DMRS type 2, the number of available DMRS CDM group(s) without data in DMRS table A may be 1, 2 or 3. In some embodiments, for DMRS type 2, the number of available DMRS CDM group(s) without data in DMRS table B may be only 1. In some embodiments, for DMRS type 2, the number of available DMRS CDM group(s) without data in DMRS table B may be only 2. In some embodiments, for DMRS type 2, the number of available DMRS CDM group(s) without data in DMRS table B may be only 3.

In some embodiments, for DMRS type 1 and if the maximum number of OFDM symbols for front-loaded DMRS or the maximum length of DMRS is 2, the number of available CWs in DMRS table A may be 1 or 2. In some embodiments, for DMRS type 2, the number of available CWs in DMRS table A may be 1 or 2. In some embodiments, the number of available CWs in DMRS table B may be only 1.

In some embodiments, if the maximum number of OFDM symbols for front-loaded DMRS or the maximum length of DMRS is 2, the number of available front-loaded symbols for DMRS in DMRS table A may be 1 or 2; while the number of available front-loaded symbols for DMRS in DMRS table B may be only 1 (for example, there may be no indication of the number of front-loaded symbols for DMRS in DMRS table B).

In some embodiments, the number of bits needed for indicating a configuration (such as, the first configuration as described above) from DMRS table A may be the same as the number of bits need for indicating a configuration (such as, the second configuration as described above) from DMRS table B.

In some embodiments, a configuration from DMRS table B may indicate a repetition number of the physical shared channel. For example, in DMRS table B, there may be several configurations indicating the same number of DMRS ports, same DMRS port indices, the same number of front-loaded symbols for DMRS and the same number of DMRS CDM groups without data. These configurations in DMRS table B may indicate different repetition numbers. For example, the repetition number indicated by a configuration in DMRS table B may be any of the following: 2, 3, 4, 5, 6, 8 or 16. In some embodiments, a configuration from DMRS table A may not indicate a repetition number of the physical shared channel. Alternatively, in some embodiments, for each configuration from DMRS table A, the repetition number of the physical shared channel can be assumed to be 1.

In some embodiments, the number of bits needed for indicating a configuration (such as, the first configuration as described above) from DMRS table A may be different from the number of bits need for indicating a configuration (such as, the second configuration as described above) from DMRS table B. For example, it is assumed that the number of bits for indicating a configuration from DMRS table A is X and the number of bits for indicating a configuration from DMRS table B is Y, where X is a positive integer and Y is a non-negative integer. In some embodiments, X may be 4, 5 or 6. In some embodiments, X is greater than Y. In some embodiments, Y may be 0, 1, 2, or 3. In some embodiments, there may be no DMRS table B. Alternatively, there may be no bit/field in DCI to indicate DMRS table B, or Y is 0.

In some embodiments, if the repetitions of the physical shared channel are disabled by the indication, there may be no additional field in the DCI for indicating the number of repetitions; while if the repetitions of the physical shared channel are enabled by the indication, there may be an additional field in the DCI for indicating the number of repetitions, as shown in FIG. 3B. For example, it is assumed that the size of the additional field is Z bits, where Z is a non-negative integer. For example, Z may be 0, 1, 2, 3, 4, 5 or 6. In some embodiments, the indicated number of repetitions in the additional field may be any of the following: 2, 3, 4, 5, 6, 8 or 16. In some embodiments, if the number of bits for indicating a configuration from DMRS table A is X and the number of bits for indicating a configuration from DMRS table B is Y (where X is a positive integer and Y is a non-negative integer, for example, X may be 4, 5 or 6 and Y may be 0, 1, 2, 3 or 4), then the number of bits for indicating a configuration from DMRS table A may equal to a sum of the number of bits for indicating a configuration from DMRS table B and the size of the additional field. That is, Y+Z=X. As such, dynamic indication of the repetition number can be supported, without increasing the indication overhead in the DCI. In some embodiments, if the number of bits for indicating a configuration from DMRS table A is X (where X is a positive integer, for example, X may be 4, 5 or 6) and there may be no DMRS table B indication, or alternatively, the number of bits for indicating a configuration from DMRS table B is 0, then the number of bits for indicating a configuration from DMRS table A may equal to the number of bits for indicating the number of repetitions in the additional field. That is, Z=X.

In some embodiments, the network device 110 may determine one or more transmission control indication (TCI) states to be used for data communications between the network device 110 and the terminal device 130 over the physical shared channel, and indicate the one or more TCI states in the DCI. A TCI state may indicate one Reference Signal (RS) set as well as parameters that configure quasi co-location (QCL) relationship between RSs within the RS set and DMRS ports for the PDSCH or PUSCH. For example, different TCI states may be used for different TRPs 120.

In some embodiments, the plurality of predefined DMRS tables may include at least a third DMRS table (also referred to as “DMRS table C” in the following), a fourth DMRS table (also referred to as “DMRS table D” in the following), a fifth DMRS table (also referred to as “DMRS table E” in the following) and a sixth DMRS table (also referred to as “DMRS table F” in the following). In some embodiments, if the indication indicates that the repetitions of the physical shared channel are disabled and only one TCI state is indicated in the DCI, DMRS table C (that is, the third DMRS table) may be selected; if the indication indicates that the repetitions of the physical shared channel are disabled and more than one TCI states are indicated in the DCI, DMRS table D (that is, the fourth DMRS table) may be selected; if the indication indicates that the repetitions of the physical shared channel are enabled and only one TCI state is indicated in the DCI, DMRS table E (that is, the fifth DMRS table) may be selected; and if the indication indicates that the repetitions of the physical shared channel are enabled and more than one TCI states are indicated in the DCI, DMRS table F (that is, the sixth DMRS table) may be selected, as shown in FIG. 3C.

In some embodiments, any two of DMRS tables C, D, E and F may be different from each other in at least one of the following: the number of available DMRS ports; the number of available front-loaded symbols for DMRS; the number of available DMRS CDM groups; and the number of available CWs.

In some embodiments, DMRS table C can be the legacy DMRS table in Release 15 (Rel-15) of 3GPP specifications. In some embodiments, for DMRS type 1 and if the maximum number of OFDM symbols for front-loaded DMRS or the maximum length of DMRS is 1, the number of available DMRS ports in DMRS table C may be 1, 2, 3 or 4. In some embodiments, for DMRS type 1 and if the maximum number of OFDM symbols for front-loaded DMRS or the maximum length of DMRS is 2, the number of available DMRS ports in DMRS table C may be 1, 2, 3, 4, 5, 6, 7 or 8. In some embodiments, for DMRS type 2 and if the maximum number of OFDM symbols for front-loaded DMRS or the maximum length of DMRS is 1, the number of available DMRS ports in DMRS table C may be 1, 2, 3, 4, 5 or 6. In some embodiments, for DMRS type 2 and if the maximum number of OFDM symbols for front-loaded DMRS or the maximum length of DMRS is 2, the number of available DMRS ports in DMRS table C may be 1, 2, 3, 4, 5, 6, 7 or 8.

In some embodiments, for DMRS type 1, the number of available DMRS CDM group(s) without data in DMRS table C may be 1 or 2. In some embodiments, for DMRS type 2, the number of available DMRS CDM group(s) without data in DMRS table C may be 1, 2 or 3.

In some embodiments, for DMRS type 1 and if the maximum number of OFDM symbols for front-loaded DMRS or the maximum length of DMRS is 2, the number of available CWs in DMRS table C may be 1 or 2. In some embodiments, for DMRS type 2, the number of available CWs in DMRS table C may be 1 or 2.

In some embodiments, if the maximum number of OFDM symbols for front-loaded DMRS or the maximum length of DMRS is 2, the number of available front-loaded symbols for DMRS in DMRS table C may be 1 or 2.

In some embodiments, in DMRS table D, the number of available DMRS ports may be 1, 2, 3 or 4. In some embodiments, in DMRS table D, the number of available DMRS ports may be 2, 3 or 4. In some embodiments, for DMRS type 1, the number of available DMRS CDM group(s) without data in DMRS table D may only be 2. In some embodiments, for DMRS type 2, the number of available DMRS CDM group(s) without data in DMRS table D may be 2 or 3. In some embodiments, the number of available CWs in DMRS table D may only be 1. In some embodiments, the number of available front-loaded symbols for DMRS in DMRS table D may only be 1.

In some embodiments, a configuration from DMRS table C and/or D may not indicate a repetition number of the physical shared channel. Alternatively, in some embodiments, for each configuration from DMRS table C and/or D, the repetition number of the physical shared channel can be assumed to be 1.

In some embodiments, in DMRS table E, the number of available DMRS ports may be 1 or 2. In some embodiments, for DMRS type 1, the number of available DMRS CDM group(s) without data in DMRS table E may only be 1. In some embodiments, for DMRS type 1, the number of available DMRS CDM group(s) without data in DMRS table E may only be 2. In some embodiments, for DMRS type 2, the number of available DMRS CDM group(s) without data in DMRS table E may only be 1. In some embodiments, for DMRS type 2, the number of available DMRS CDM group(s) without data in DMRS table E may only be 3. In some embodiments, the number of available CWs in DMRS table E may only be 1. In some embodiments, the number of available front-loaded symbols for DMRS in DMRS table E may only be 1.

In some embodiments, in DMRS table F, the number of available DMRS ports may be 1 or 2. In some embodiments, for DMRS type 1, the number of available DMRS CDM group(s) without data in DMRS table F may only be 1. In some embodiments, for DMRS type 1, the number of available DMRS CDM group(s) without data in DMRS table F may only be 2. In some embodiments, for DMRS type 2, the number of available DMRS CDM group(s) without data in DMRS table F may only be 1. In some embodiments, for DMRS type 2, the number of available DMRS CDM group(s) without data in DMRS table F may only be 3. In some embodiments, the number of available CWs in DMRS table F may only be 1. In some embodiments, the number of available front-loaded symbols for DMRS in DMRS table F may only be 1.

In some embodiments, the number of bits needed for indicating a configuration from DMRS table C, the number of bits needed for indicating a configuration from DMRS table D, the number of bits needed for indicating a configuration from DMRS table E and the number of bits needed for indicating a configuration from DMRS table F may be the same.

In some embodiments, a configuration from DMRS table E and/or F may indicate a repetition number of the physical shared channel. For example, in DMRS table E and/or F, there may be several configurations indicating the same number of DMRS ports, same DMRS port indices, the same number of front-loaded symbols for DMRS and the same number of DMRS CDM groups without data. These configurations may indicate different repetition numbers. For example, the repetition number indicated by a configuration in DMRS table E and/or F may be any of the following: 2, 3, 4, 5, 6, 8 or 16. In some embodiments, a configuration from DMRS table C and/or D may not indicate a repetition number of the physical shared channel.

In some embodiments, the number of bits needed for indicating a configuration from DMRS table C may be different from the number of bits need for indicating a configuration from DMRS table E. Alternatively, or in addition, the number of bits needed for indicating a configuration from DMRS table D may be different from the number of bits need for indicating a configuration from DMRS table F. For example, it is assumed that the number of bits for indicating a configuration from DMRS table C or D is X, the number of bits for indicating a configuration from DMRS table E is Y1 and the number of bits for indicating a configuration from DMRS table F is Y2, where X is a positive integer and Y1 and Y2 are non-negative integers. In some embodiments, X may be 4, 5 or 6. In some embodiments, X is greater than Y1. In some embodiments, X is greater than Y2. In some embodiments, Y1 may be 0, 1, 2, or 3. In some embodiments, Y2 may be 0, 1, 2, or 3.

In some embodiments, if the indication indicates that the repetitions of the physical shared channel are disabled, there may be no additional field in the DCI for indicating the number of repetitions; while if the repetitions of the physical shared channel are enabled by the indication, there may be an additional field in the DCI for indicating the number of repetitions, as shown in FIG. 3B. For example, it is assumed that if only one TCI state is indicated in the DCI, the size of the additional field is Z1 bits, where Z1 is a non-negative integer. For example, Z1 may be 0, 1, 2, 3 or 4. It is also assumed that if more than one TCI states are indicated in the DCI, the size of the additional field is Z2 bits, where Z2 is a non-negative integer. For example, Z2 may be 0, 1, 2, 3 or 4. In some embodiments, the indicated number of repetitions in the additional field may be any of the following: 2, 3, 4, 5, 6, 8 or 16. In some embodiments, X, Y1 and Z1 may satisfy the following equation: Y1+Z1=X. In some embodiments, X, Y2 and Z2 may satisfy the following equation: Y2+Z2=X. As such, dynamic indication of the repetition number can be supported, without increasing the indication overhead in the DCI.

In some embodiments, if only one TCI state is indicated to the terminal device 130, the TCI state may be applied to all of DMRS ports indicated to the terminal device 130. In some embodiments, if only one TCI state is indicated, and if Phase Tracking Reference signal (PTRS) is configured to the terminal device 130, the number of PTRS ports may be only one. In some embodiments, a first TCI state and a second TCI state may be indicated to the terminal device 130 and the terminal device 130 may be indicated that the repetitions of the physical shared channel are disabled. In some embodiments, if the indicated DMRS ports belong to only one CDM group, the first TCI state may be associated to the DMRS ports. In some embodiments, in case that more than one TCI states are indicated, the indicated DMRS ports belong to only one CDM group and PTRS is configured to the terminal device 130, the number of PTRS ports may be only one. In some embodiments, if the indicated DMRS ports belong to more than one CDM groups, the first and second TCI states may be associated to different DMRS ports. In some embodiments, in case that more than one TCI states are indicated, the indicated DMRS ports belong to more than one CDM groups, the repetition are disabled, and PTRS is configured to the terminal device 130, the number of PTRS ports may be two. In some embodiments, a first TCI state and a second TCI state may indicated to the terminal device 130 and the terminal device 130 may be indicated that the repetitions of the physical shared channel are enabled (that is, the repetition number is greater than 1). In this event, for some of the repetitions, the first TCI state may be associated to all of DMRS ports indicated to the terminal device 130; while for other of the repetitions, the second TCI state may be associated to all of the DMRS ports indicated to the terminal device 130. In some embodiments, in case that more than one TCI states are indicated, the indicated DMRS ports belong to more than one CDM groups, the repetitions are enabled, and PTRS is configured to the terminal device 130, for each repetition transmission occasion, the number of PTRS ports may be only one. In some embodiments, in case that more than one TCI states are indicated, the indicated DMRS ports belong to more than one CDM groups, the repetitions are enabled, and PTRS is configured to the terminal device 130, for each repetition transmission occasion, the number of PTRS ports may be only one. In addition, for the repetition transmission occasions associated with different TCI states, the PTRS port index may be different.

In some embodiments, if the repetition number is configured via a higher layer parameter and the repetition number exceeds 1, a new DMRS table can be used for generating the DCI. In some embodiments, in the new DMRS table, only one or two DMRS ports are available. In some embodiments, for DMRS type 1, the number of available CDM groups without data in the new DMRS table may be 2. In some embodiments, for DMRS type 2, the number of available CDM groups without data in the new DMRS table may be 3. In some embodiments, for a configuration from the new DMRS table indicating only one DMRS port, DMRS port 0 may be used. In some embodiments, for a configuration from the new DMRS table indicating two DMRS ports, DMRS port 0 and DMRS port 2 may be used. In some embodiments, there may be several configurations in the new DMRS table indicating only one DMRS port and these configurations may indicate different repetition numbers. In some embodiments, there may be several configurations in the new DMRS table indicating two DMRS ports and these configurations may indicate different repetition numbers. In some embodiments, the number of bits in the DCI for indicating a configuration from a DMRS table may be 0. In this event, DMRS port 0 may be assumed to be used for DMRS communication, and the number of DMRS CDM groups without data can be assumed to be 2 or 3 for DMRS type 1 and DMRS type 2 respectively.

In some embodiments, if the maximum number of layers of the physical shared channel is 2, there may be only 1 bit in the DCI for indicating a DMRS configuration. For example, two DMRS configuration may be supported, one indicating DMRS port 0 and the other indicating DMRS port 0 and DMRS port 2. In some embodiments, if the maximum number of layers of the physical shared channel is 1, there may be no bit in the DCI for indicating a DMRS configuration. For example, DMRS port 0 may be assumed to be used for DMRS communication.

In some embodiments, different schemes for multi-TRP based ultra-reliable and low latency communication (URLLC), scheduled by single DCI at least, can be clarified as following: scheme 1 (Space Division Multiplexing) supporting n TCI states within a single slot, with overlapped time and frequency resource allocation; Scheme 2 (FDM) supporting n TCI states within a single slot, with non-overlapped frequency resource allocation, where each non-overlapped frequency resource allocation is associated with one TCI state and single/multiple DMRS port(s) are associated with all non-overlapped frequency resource allocation; Scheme 3 (TDM) supporting n TCI states within a single slot, with non-overlapped time resource allocation; and Scheme 4 (TDM) supporting n TCI states within K (n<=K) different slots. In scheme 1, each transmission occasion is a layer or a set of layers of the same TB, with each layer or layer set being associated with one TCI and one set of DMRS port(s). Single codeword (CW) with one redundancy version (RV) is used across all spatial layers or layer sets. From the UE perspective, different coded bits are mapped to different layers or layer sets with the same mapping rule as in Rel-15. Scheme 2 can be further divided into two sub-schemes: Scheme 2a and Scheme 2b. In Scheme 2a, a single CW with one RV is used across the full resource allocation. From UE perspective, the common RB mapping (CW to layer mapping as in Rel-15) is applied across the full resource allocation. In Scheme 2b, a single CW with one RV is used for each non-overlapped frequency resource allocation. The RVs corresponding to each non-overlapped frequency resource allocation can be the same or different. In Scheme 3, each transmission occasion of the TB has one TCI and one RV with the time granularity of mini-slot. All transmission occasion (s) within the slot use a common MCS with same single or multiple DMRS port(s). RV/TCI state can be same or different among transmission occasions. In scheme 4, each transmission occasion of the TB has one TCI and one RV. All transmission occasion (s) across K slots use a common MCS with same single or multiple DMRS port(s). RV/TCI state can be same or different among transmission occasions.

In some embodiments, DMRS table A may be different from DMRS table B in at least one of the following: the number of available DMRS ports; the number of available front-loaded symbols for DMRS; the number of available DMRS CDM groups; the number of repetitions; the repetition schemes (for example, scheme 1, scheme 2a, scheme 2b, scheme 3, scheme 4 and/or any combination thereof); the symbol/slot offset between repetitions in time domain; the resource allocation for repetitions in frequency domain; the resource allocation for repetitions in time domain; the resource block offset or resource block group offset between repetitions in frequency domain; the RV sequence for repetitions; the number of TCI states; and the number of available CWs.

In some embodiments, a configuration from DMRS table B may indicate at least one of the following: a repetition number, a repetition scheme, an RV sequence for repetitions, the number of TCI states, repetitions across different slots, repetitions within a single slot, a symbol/slot offset between repetitions in time domain and/or an offset of RBs between repetitions in frequency domain of the physical shared channel. In some embodiments, in DMRS table B, there may be several configurations indicating the same number of DMRS ports, same DMRS port indices, the same number of front-loaded symbols for DMRS and the same number of DMRS CDM groups without data. These configurations in DMRS table B may indicate different repetition numbers. For example, the repetition number indicated by a configuration in DMRS table B may be any of the following: 2, 3, 4, 5, 6, 8 or 16. In some embodiments, a configuration from DMRS table A may not indicate a repetition number of the physical shared channel. Alternatively, in some embodiments, for each configuration from DMRS table A, the repetition number of the physical shared channel can be assumed to be 1.

In some embodiments, in DMRS table B, there may be several configurations indicating the same number of DMRS ports, same DMRS port indices, the same number of front-loaded symbols for DMRS and the same number of DMRS CDM groups without data. These configurations in DMRS table B may indicate different repetition schemes. For example, the repetition scheme indicated by a configuration in DMRS table B may be any of scheme 1, scheme 2a, scheme 2b, scheme 3 or scheme 4. In some embodiments, a configuration from DMRS table A may not indicate a repetition scheme of the physical shared channel. Alternatively, in some embodiments, for each configuration from DMRS table A, the repetition scheme of the physical shared channel can be assumed to be scheme 1.

In some embodiments, in DMRS table B, there may be several configurations indicating the same number of DMRS ports, same DMRS port indices, the same number of front-loaded symbols for DMRS and the same number of DMRS CDM groups without data. These configurations in DMRS table B may indicate different values of symbol/slot offset between repetitions. For example, the value of symbol/slot offset between repetitions indicated by a configuration in DMRS table B may be any of the following: 0, 1, 2, 3, 4, 5, 6, or 7. For example, the value of symbol offset between repetitions may be used for scheme 3. In some embodiments, a configuration from DMRS table A may not indicate a value of symbol/slot offset between repetitions of the physical shared channel. In some embodiments, the value of symbol offset may be only applied between repetitions associated with different TCI states. In some embodiments, the symbol offset may be calculated from the last symbol of one repetition to the first symbol of the following repetition. In some embodiments, the symbol offset may be calculated from the first symbol of one repetition to the first symbol of the following repetition. In some embodiments, the symbol offset may be calculated from the last symbol of one repetition to the last symbol of the following repetition.

In some embodiments, in DMRS table B, there may be several configurations indicating the same number of DMRS ports, same DMRS port indices, the same number of front-loaded symbols for DMRS and the same number of DMRS CDM groups without data. These configurations in DMRS table B may indicate different values of RB offset between repetitions and/or index of starting RB for each repetition. In some embodiments, the value of RB offset between repetitions indicated by a configuration in DMRS table B may be a non-negative integer. For example, the value of RB offset may be no less than 0 and no greater than 276. For example, the value of RB offset between repetitions may be used for scheme 2a and/or scheme 2b. In some embodiments, the RB offset may be calculated from the end of one repetition to the start of the following repetition. In some embodiments, the RB offset may be calculated from the start of one repetition to the start of the following repetition. In some embodiments, the RB offset may be calculated from the end of one repetition to the end of the following repetition. In some embodiments, a configuration from DMRS table A may not indicate a value of RB offset between repetitions of the physical shared channel.

In some embodiments, in DMRS table B, there may be several configurations indicating the same number of DMRS ports, same DMRS port indices, the same number of front-loaded symbols for DMRS and the same number of DMRS CDM groups without data. These configurations in DMRS table B may indicate different RV sequences for repetitions of the physical shared channel. In some embodiments, a configuration in DMRS table B may indicate an RV sequence for the repetitions or a cyclic shift of an RV sequence. For example, the RV sequence indicated by the configuration may be any of the following: {0, 3}, {0, 0}, {0, 2}, {0, 2, 3, 1}, {0, 3, 2, 1}, {0, 3, 0, 3} or {0, 0, 0, 0}. In some embodiments, a configuration from DMRS table A may not indicate an RV sequence for repetitions of the physical shared channel.

In some embodiments, in DMRS table B, there may be several configurations indicating the same number of DMRS ports, same DMRS port indices, the same number of front-loaded symbols for DMRS and the same number of DMRS CDM groups without data. These configurations in DMRS table B may indicate different numbers of TCI states. In some embodiments, the number of TCI states indicated by a configuration in DMRS table B may be any of the following: 1, 2, 3 or 4. In some embodiments, a configuration from DMRS table A may not indicate the number of TCI states for repetitions of the physical shared channel.

In some embodiments, if the repetitions of the physical shared channel are disabled by the indication, there may be no additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4. In some embodiments, if the repetitions of the physical shared channel are enabled by the indication, there may be one or more additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4.

In some embodiments, there may be an additional field in DCI for indicating the repetition scheme. It is assumed that the size of the additional field is W₁ bits, where W₁ is a non-negative integer. For example, W₁ may be 0, 1, 2, 3, 4, 5 or 6. In some embodiments, the repetition scheme indicated in the additional field may be any of the following: scheme 1, scheme 2a, scheme 2b, scheme 3, scheme 4 or any combination thereof. In some embodiments, there may be an additional field in DCI for indicating the value of symbol/slot offset between repetitions in time domain. It is assumed that the size of the additional field is W₂ bits, where W₂ is a non-negative integer. For example, W₂ may be 0, 1, 2, 3, 4, 5 or 6. In some embodiments, the value of symbol/slot offset between repetitions may be any of the following: 0, 1, 2, 3, 4, 5, 6 or 7. In some embodiments, there may be an additional field in DCI for indicating the value of RB offset between repetitions in frequency domain. It is assumed that the size of the additional field is W₃ bits, where W₃ is a non-negative integer. For example, W₃ may be 0, 1, 2, 3, 4, 5 or 6. In some embodiments, the value of the additional field may be associated with one predefined value of RB offset configured via RRC and/or MAC signaling. For example, different values of the additional field may be associated with different predefined values of RB offset configured in RRC and/or MAC signaling. In some embodiments, there may be an additional field in DCI for indicating an RV sequence for repetitions. It is assumed that the size of the additional field is W₄ bits, where W₄ is a non-negative integer. For example, W₄ may be 0, 1, 2, 3, 4, 5 or 6. In some embodiments, the additional field may indicate an RV sequence for the repetitions or a cyclic shift of an RV sequence. For example, the RV sequence indicated in the additional field may be any of the following: {0, 3}, {0, 0}, {0, 2}, {0, 2, 3, 1}, {0, 3, 2, 1}, {0, 3, 0, 3} or {0, 0, 0, 0}. In some embodiments, there may be an additional field in DCI for indicating the number of TCI states. It is assumed that the size of the additional field is W₅ bits, where W₅ is a non-negative integer. For example, W₅ may be 0, 1 or 2. In some embodiments, the number of TCI states indicated in the additional field may be any of the following: 1, 2, 3 or 4. In some embodiments, if the number of bits for indicating a configuration from DMRS table A is X and the number of bits for indicating a configuration from DMRS table B is Y (where X is a positive integer and Y is a non-negative integer, for example, X may be 4, 5 or 6 and Y may be 0, 1, 2, 3 or 4), then the number of bits for indicating a configuration from DMRS table A may equal to a sum of the number of bits for indicating a configuration from DMRS table B and the size of the one or more additional field. That is, Y+Z+W₁+W₂+W₃+W₄+W₅=X. In some embodiments, at least one of Z, W₁, W₂, W₃, W₄ and W₅ may be equal to zero. As such, dynamic indication of any of the repetition number, the repetition scheme, the sequence for repetitions, the number of TCI states, the value of symbol/slot offset between repetitions in time domain or the value of RB offset between repetitions in frequency domain can be supported, without increasing the indication overhead in the DCI.

In some embodiments, any two of DMRS tables C, D, E and F may be different from each other in at least one of the following: the number of available DMRS ports; the number of available front-loaded symbols for DMRS; the number of available DMRS CDM groups; and the number of available CWs; the number of repetitions; the repetition schemes (for example, scheme 1, scheme 2a, scheme 2b, scheme 3, scheme 4 and/or any combination thereof); the symbol/slot offset between repetitions in time domain; the resource allocation for repetitions in frequency domain; the resource allocation for repetitions in time domain; the resource block offset or resource block group offset between repetitions in frequency domain; the RV sequence for repetitions and the number of TCI states.

In some embodiments, any two of DMRS tables C, D, E and F may be different from each other in at least one of the following: the number of available DMRS ports; the number of available front-loaded symbols for DMRS; the number of available DMRS CDM groups; the number of repetitions; the repetition schemes (for example, scheme 1, scheme 2a, scheme 2b, scheme 3, scheme 4 and/or any combination thereof); the RV sequence for repetitions; the number of TCI states; the symbol/slot offset between repetitions in time domain; the resource allocation for repetitions in frequency domain; the resource allocation for repetitions in time domain; the resource block offset or resource block group offset between repetitions in frequency domain; and the number of available CWs.

In some embodiments, a configuration from DMRS table E and/or F may indicate at least one of the following: a repetition number, a repetition scheme, an RV sequence for repetitions, the number of TCI states, repetitions across different slots, repetitions within a single slot, a symbol/slot offset between repetitions in time domain and an offset of RBs between repetitions in frequency domain of the physical shared channel. For example, in DMRS table E and/or F, there may be several configurations indicating the same number of DMRS ports, same DMRS port indices, the same number of front-loaded symbols for DMRS and the same number of DMRS CDM groups without data. These configurations may indicate different repetition numbers. For example, the repetition number indicated by a configuration in DMRS table E and/or F may be any of the following: 2, 3, 4, 5, 6, 8 or 16. In some embodiments, a configuration from DMRS table C and/or D may not indicate a repetition number of the physical shared channel.

In some embodiments, in DMRS table E and/or F, there may be several configurations indicating the same number of DMRS ports, same DMRS port indices, the same number of front-loaded symbols for DMRS and the same number of DMRS CDM groups without data. These configurations in DMRS table E and/or F may indicate different repetition schemes. For example, the repetition scheme indicated by a configuration in DMRS table E and/or F may be any of scheme 1, scheme 2a, scheme 2b, scheme 3 and scheme 4. In some embodiments, a configuration from DMRS table C and/or D may not indicate a repetition scheme of the physical shared channel. Alternatively, in some embodiments, for each configuration from DMRS table C and/or D, the repetition scheme of the physical shared channel can be assumed to be scheme 1.

In some embodiments, in DMRS table E and/or F, there may be several configurations indicating the same number of DMRS ports, same DMRS port indices, the same number of front-loaded symbols for DMRS and the same number of DMRS CDM groups without data. These configurations in DMRS table E and/or F may indicate different values of symbol/slot offset between repetitions. For example, the value of symbol/slot offset between repetitions indicated by a configuration in DMRS table E and/or F may be any of the following: 0, 1, 2, 3, 4, 5, 6 or 7. For example, the value of symbol offset between repetitions may be used for scheme 3. In some embodiments, a configuration from DMRS table C and/or D may not indicate a value of symbol/slot offset between repetitions of the physical shared channel. In some embodiments, the value of symbol offset may be only applied between repetitions associated with different TCI states. In some embodiments, the symbol offset may be calculated from the last symbol of one repetition to the first symbol of the following repetition. In some embodiments, the symbol offset may be calculated from the first symbol of one repetition to the first symbol of the following repetition. In some embodiments, the symbol offset may be calculated from the last symbol of one repetition to the last symbol of the following repetition.

In some embodiments, in DMRS table E and/or F, there may be several configurations indicating the same number of DMRS ports, same DMRS port indices, the same number of front-loaded symbols for DMRS and the same number of DMRS CDM groups without data. These configurations in DMRS table E and/or F may indicate different values of RB offset between repetitions and/or index of starting RB for each repetition. In some embodiments, the value of RB offset between repetitions indicated by a configuration in DMRS table E and/or F may be a non-negative integer. For example, the value of RB offset may be no less than 0 and no greater than 276. For example, the value of RB offset between repetitions may be used for scheme 2a and/or scheme 2b. In some embodiments, the RB offset may be calculated from the end of one repetition to the start of the following repetition. In some embodiments, the RB offset may be calculated from the start of one repetition to the start of the following repetition. In some embodiments, the RB offset may be calculated from the end of one repetition to the end of the following repetition. In some embodiments, a configuration from DMRS table C and/or D may not indicate a value of RB offset between repetitions of the physical shared channel.

In some embodiments, in DMRS table E and/or F, there may be several configurations indicating the same number of DMRS ports, same DMRS port indices, the same number of front-loaded symbols for DMRS and the same number of DMRS CDM groups without data. These configurations in DMRS table E and/or F may indicate different RV sequences for repetitions of the physical shared channel. In some embodiments, a configuration from DMRS table E and/or F may indicate an RV sequence for the repetitions or a cyclic shift of an RV sequence. For example, the RV sequence indicated by the configuration may be any of the following: {0, 3}, {0, 0}, {0, 2}, {0, 2, 3, 1}, {0, 3, 2, 1}, {0, 3, 0, 3} or {0, 0, 0, 0}. In some embodiments, a configuration from DMRS table C and/or D may not indicate an RV sequence for repetitions of the physical shared channel.

In some embodiments, in DMRS table E and/or F, there may be several configurations indicating the same number of DMRS ports, same DMRS port indices, the same number of front-loaded symbols for DMRS and the same number of DMRS CDM groups without data. These configurations in DMRS table E and/or F may indicate different numbers of TCI states. In some embodiments, the number of TCI states indicated by a configuration in DMRS table E and/or F may be any of the following: 1, 2, 3 or 4. In some embodiments, a configuration from DMRS table C and/or D may not indicate the number of TCI states of the physical shared channel.

In some embodiments, if only one TCI state is indicated in the DCI and if the repetitions of the physical shared channel are disabled by the indication, there may be no additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4. In some embodiments, if the repetitions of the physical shared channel are enabled by the indication, there may be one or more additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4.

In some embodiments, if more than one TCI states are indicated in the DCI and if the repetitions of the physical shared channel are disabled by the indication, there may be no additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4. In some embodiments, if the repetitions of the physical shared channel are enabled by the indication, there may be one or more additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4.

In some embodiments, if only one TCI state is indicated in the DCI, there may be an additional field in DCI for indicating the repetition scheme. It is assumed that the size of the additional field is U₁ bits, where U₁ is a non-negative integer. For example, U₁ may be 0, 1, 2, 3, 4, 5 or 6. In some embodiments, the repetition scheme indicated in the additional field may be any of the following: scheme 1, scheme 2a, scheme 2b, scheme 3, scheme 4 or any combination thereof. In some embodiments, there may be an additional field in DCI for indicating the value of symbol/slot offset between repetitions in time domain. It is assumed that the size of the additional field is U₂ bits, where U₂ is a non-negative integer. For example, U₂ may be 0, 1, 2, 3, 4, 5 or 6. In some embodiments, the value of symbol/slot offset between repetitions may be any of the following: 0, 1, 2, 3, 4, 5, 6 or 7. In some embodiments, there may be an additional field in DCI for indicating the value of RB offset between repetitions in frequency domain. It is assumed that the size of the additional field is U₃ bits, where U₃ is a non-negative integer. For example, U₃ may be 0, 1, 2, 3, 4, 5 or 6. In some embodiments, the value of the additional field may be associated with one predefined value of RB offset configured via RRC and/or MAC signaling. For example, different values of the additional field may be associated with different predefined values of RB offset configured in RRC and/or MAC signaling. In some embodiments, there may be an additional field in DCI for indicating an RV sequence for repetitions. It is assumed that the size of the additional field is U₄ bits, where U₄ is a non-negative integer. For example, U₄ may be 0, 1, 2, 3, 4, 5 or 6. In some embodiments, the additional field may indicate an RV sequence for the repetitions or a cyclic shift of an RV sequence. For example, the RV sequence indicated in the additional field may be any of the following: {0, 3}, {0, 0}, {0, 2}, {0, 2, 3, 1}, {0, 3, 2, 1}, {0, 3, 0, 3} or {0, 0, 0, 0}. In some embodiments, there may be an additional field in DCI for indicating the number of TCI states. It is assumed that the size of the additional field is U₅ bits, where U₅ is a non-negative integer. For example, U₅ may be 0, 1 or 2. In some embodiments, the number of TCI states indicated in the additional field may be any of the following: 1, 2, 3 or 4. In some embodiments, if the number of bits for indicating a configuration from DMRS table A is X and the number of bits for indicating a configuration from DMRS table B is Y (where X is a positive integer and Y is a non-negative integer, for example, X may be 4, 5 or 6 and Y may be 0, 1, 2, 3 or 4), then the number of bits for indicating a configuration from DMRS table A may equal to a sum of the number of bits for indicating a configuration from DMRS table B and the size of the one or more additional field. That is, Y+Z1+U₁+U₂+U₃+U₄+U₅=X. In some embodiments, at least one of Z1, U₁, U₂, U₃, U₄ and U₅ may be equal to zero. As such, dynamic indication of any of the repetition number, the repetition scheme, the sequence for repetitions, the number of TCI states, the value of symbol/slot offset between repetitions in time domain or the value of RB offset between repetitions in frequency domain can be supported, without increasing the indication overhead in the DCI.

In some embodiments, if more than one TCI states are indicated in the DCI, there may be an additional field in DCI for indicating the repetition scheme. It is assumed that the size of the additional field is V₁ bits, where V₁ is a non-negative integer. For example, V₁ may be 0, 1, 2, 3, 4, 5 or 6. In some embodiments, the repetition scheme indicated in the additional field may be any of the following: scheme 1, scheme 2a, scheme 2b, scheme 3, scheme 4 or any combination thereof. In some embodiments, there may be an additional field in DCI for indicating the value of symbol/slot offset between repetitions in time domain. It is assumed that the size of the additional field is V₂ bits, where V₂ is a non-negative integer. For example, V₂ may be 0, 1, 2, 3, 4, 5 or 6. In some embodiments, the value of symbol/slot offset between repetitions may be any of the following: 0, 1, 2, 3, 4, 5, 6 or 7. In some embodiments, there may be an additional field in DCI for indicating the value of RB offset between repetitions in frequency domain. It is assumed that the size of the additional field is V₃ bits, where V₃ is a non-negative integer. For example, V₃ may be 0, 1, 2, 3, 4, 5 or 6. In some embodiments, the value of the additional field may be associated with one predefined value of RB offset configured via RRC and/or MAC signaling. For example, different values of the additional field may be associated with different predefined values of RB offset configured in RRC and/or MAC signaling. In some embodiments, there may be an additional field in DCI for indicating an RV sequence for repetitions. It is assumed that the size of the additional field is V₄ bits, where V₄ is a non-negative integer. For example, V₄ may be 0, 1, 2, 3, 4, 5 or 6. In some embodiments, the additional field may indicate an RV sequence for the repetitions or a cyclic shift of an RV sequence. For example, the RV sequence indicated in the additional field may be any of the following: {0, 3}, {0, 0}, {0, 2}, {0, 2, 3, 1}, {0, 3, 2, 1}, {0, 3, 0, 3} or {0, 0, 0, 0}. In some embodiments, there may be an additional field in DCI for indicating the number of TCI states. It is assumed that the size of the additional field is V₅ bits, where V₅ is a non-negative integer. For example, V₅ may be 0, 1 or 2. In some embodiments, the number of TCI states indicated in the additional field may be any of the following: 1, 2, 3 or 4. In some embodiments, if the number of bits for indicating a configuration from DMRS table A is X and the number of bits for indicating a configuration from DMRS table B is Y (where X is a positive integer and Y is a non-negative integer, for example, X may be 4, 5 or 6 and Y may be 0, 1, 2, 3 or 4), then the number of bits for indicating a configuration from DMRS table A may equal to a sum of the number of bits for indicating a configuration from DMRS table B and the size of the one or more additional field. That is, Y+Z2+V₁+V₂+V₃+V₄+V₅=X. In some embodiments, at least one of Z1, V₁, V₂, V₃, V₄ and V₅ may be equal to zero. As such, dynamic indication of any of the repetition number, the repetition scheme, the sequence for repetitions, the number of TCI states, the value of symbol/slot offset between repetitions in time domain or the value of RB offset between repetitions in frequency domain can be supported, without increasing the indication overhead in the DCI.

In some embodiments, the plurality of predefined DMRS tables may include at least a first DMRS table (also referred to as “DMRS table G” in the following) and a second DMRS table (also referred to as “DMRS table H” in the following). DMRS table G may be different from DMRS table H. In some embodiments, if only one TCI state is indicated in the DCI, DMRS table G (that is, the first DMRS table) can be selected; and if more than one TCI states are indicated in the DCI, DMRS table H (that is, the second DMRS table) can be selected.

In some embodiments, DMRS table G may be different from DMRS table H in at least one of the following: the number of available DMRS ports; the number of available front-loaded symbols for DMRS; the number of available DMRS CDM groups; and the number of available CWs; the number of repetitions; the repetition schemes (for example, scheme 1, scheme 2a, scheme 2b, scheme 3, scheme 4 and/or any combination thereof); the RV sequence for repetitions; the number of TCI states; the symbol/slot offset between repetitions in time domain; the resource allocation for repetitions in frequency domain; the resource allocation for repetitions in time domain; the resource block offset or resource block group offset between repetitions in frequency domain.

In some embodiments, for DMRS type 1 and if the maximum number of OFDM symbols for front-loaded DMRS or the maximum length of DMRS is 1, the number of available DMRS ports in DMRS table G may be 1, 2, 3 or 4. In some embodiments, for DMRS type 1 and if the maximum number of OFDM symbols for front-loaded DMRS or the maximum length of DMRS is 2, the number of available DMRS ports in DMRS table G may be 1, 2, 3, 4, 5, 6, 7 or 8. In some embodiments, for DMRS type 2 and if the maximum number of OFDM symbols for front-loaded DMRS or the maximum length of DMRS is 1, the number of available DMRS ports in DMRS table G may be 1, 2, 3, 4, 5 or 6. In some embodiments, for DMRS type 2 and if the maximum number of OFDM symbols for front-loaded DMRS or the maximum length of DMRS is 2, the number of available DMRS ports in DMRS table G may be 1, 2, 3, 4, 5, 6, 7 or 8. In some embodiments, the number of available DMRS ports in DMRS table H may be 1, 2, 3 or 4. In some embodiments, the number of available DMRS ports in DMRS table H may be 2, 3 or 4.

In some embodiments, for DMRS type 1, the number of available DMRS CDM group(s) without data in DMRS table G may be 1 or 2. In some embodiments, for DMRS type 1, the number of available DMRS CDM group(s) without data in DMRS table H may be only 2. In some embodiments, for DMRS type 2, the number of available DMRS CDM group(s) without data in DMRS table G may be 1, 2 or 3. In some embodiments, for DMRS type 2, the number of available DMRS CDM group(s) without data in DMRS table H may be 2 or 3.

In some embodiments, for DMRS type 1 and if the maximum number of OFDM symbols for front-loaded DMRS or the maximum length of DMRS is 2, the number of available CWs in DMRS table G may be 1 or 2. In some embodiments, for DMRS type 2, the number of available CWs in DMRS table G may be 1 or 2. In some embodiments, the number of available CWs in DMRS table H may be only 1.

In some embodiments, if the maximum number of OFDM symbols for front-loaded DMRS or the maximum length of DMRS is 2, the number of available front-loaded symbols for DMRS in DMRS table G may be 1 or 2; while the number of available front-loaded symbols for DMRS in DMRS table H may be only 1 (for example, there may be no indication of the number of front-loaded symbols for DMRS in DMRS table H).

In some embodiments, the number of bits needed for indicating a configuration (such as, the first configuration as described above) from DMRS table G may be the same as the number of bits need for indicating a configuration (such as, the second configuration as described above) from DMRS table H.

In some embodiments, if repetitions of the physical shared channel are enabled via RRC signaling, MAC layer signaling and/or DCI, a configuration from DMRS table G and/or H may indicate at least one of the following: a repetition number, a repetition scheme, an RV sequence for repetitions, the number of TCI states, repetitions across different slots, repetitions within a single slot, a symbol/slot offset between repetitions in time domain and/or an offset of RBs between repetitions in frequency domain of the physical shared channel. For example, in DMRS table G and/or H, there may be several configurations indicating the same number of DMRS ports, same DMRS port indices, the same number of front-loaded symbols for DMRS and the same number of DMRS CDM groups without data. These configurations in DMRS table G and/or H may indicate different repetition numbers. For example, the repetition number indicated by a configuration from DMRS table G and/or H may be any of the following: 1, 2, 3, 4, 5, 6, 8 or 16.

In some embodiments, if repetitions of the physical shared channel are enabled via RRC signaling, MAC layer signaling and/or DCI, in DMRS table G and/or H, there may be several configurations indicating the same number of DMRS ports, same DMRS port indices, the same number of front-loaded symbols for DMRS and the same number of DMRS CDM groups without data. These configurations in DMRS table G and/or H may indicate different repetition schemes. For example, the repetition scheme indicated by a configuration from DMRS table H may be scheme 1, scheme 2a, scheme 2b, scheme 3 or scheme 4. For another example, the repetition scheme indicated by a configuration from DMRS table G may be scheme 2b, scheme 3 or scheme 4.

In some embodiments, in DMRS table G and/or H, there may be several configurations indicating the same number of DMRS ports, same DMRS port indices, the same number of front-loaded symbols for DMRS and the same number of DMRS CDM groups without data. These configurations in DMRS table G and/or H may indicate different values of symbol offset between repetitions. For example, the value of symbol offset between repetitions indicated by a configuration in DMRS table G and/or H may be any of the following: 0, 1, 2, 3, 4, 5, 6, or 7. For example, the value of symbol offset between repetitions may be used for scheme 3. In some embodiments, the value of symbol offset may be only applied between repetitions associated with different TCI states. In some embodiments, the symbol offset may be calculated from the last symbol of one repetition to the first symbol of the following repetition. In some embodiments, the symbol offset may be calculated from the first symbol of one repetition to the first symbol of the following repetition. In some embodiments, the symbol offset may be calculated from the last symbol of one repetition to the last symbol of the following repetition.

In some embodiments, in DMRS table G and/or H, there may be several configurations indicating the same number of DMRS ports, same DMRS port indices, the same number of front-loaded symbols for DMRS and the same number of DMRS CDM groups without data. These configurations in DMRS table G and/or H may indicate different values of RB offset between repetitions and/or index of starting RB for each repetition. In some embodiments, the value of RB offset between repetitions indicated by a configuration in DMRS table G and/or H may be a non-negative integer. For example, the value of RB offset may be no less than 0 and no greater than 276. For example, the value of RB offset between repetitions may be used for scheme 2a and/or scheme 2b. In some embodiments, the RB offset may be calculated from the end of one repetition to the start of the following repetition. In some embodiments, the RB offset may be calculated from the start of one repetition to the start of the following repetition. In some embodiments, the RB offset may be calculated from the end of one repetition to the end of the following repetition.

In some embodiments, in DMRS table G and/or H, there may be several configurations indicating the same number of DMRS ports, same DMRS port indices, the same number of front-loaded symbols for DMRS and the same number of DMRS CDM groups without data. These configurations in DMRS table G and/or H may indicate different RV sequences for repetitions of the physical shared channel. In some embodiments, a configuration from DMRS table G and/or H may indicate an RV sequence for the repetitions or a cyclic shift of an RV sequence. For example, the RV sequence indicated by the configuration may be any of the following: {0, 3}, {0, 0}, {0, 2}, {0, 2, 3, 1}, {0, 3, 2, 1}, {0, 3, 0, 3} or {0, 0, 0, 0}.

In some embodiments, in DMRS table G and/or H, there may be several configurations indicating the same number of DMRS ports, same DMRS port indices, the same number of front-loaded symbols for DMRS and the same number of DMRS CDM groups without data. These configurations in DMRS table G and/or H may indicate different numbers of TCI states. In some embodiments, the number of TCI states indicated by a configuration in DMRS table E and/or F may be any of the following: 1, 2, 3 or 4.

In some embodiments, if only one TCI state is indicated in the DCI, there may be no additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4. In some embodiments, if more than one TCI states are indicated in the DCI, there may be one or more additional field in the DCI for indicating at least one of the following: the number of repetitions, the repetition scheme, an RV sequence for repetitions, the number of TCI states, the value of symbol/slot offset between repetitions in time domain, the value of RB offset between repetitions in frequency domain, whether repetitions are based on scheme 2a, whether repetitions are based on scheme 2b, whether repetitions are based on scheme 3, and whether repetitions are based on scheme 4.

In some embodiments, there may be an additional field in DCI for indicating the repetition scheme. It is assumed that the size of the additional field is P₁ bits, where P₁ is a non-negative integer. For example, P₁ may be 0, 1, 2, 3, 4, 5 or 6. In some embodiments, the repetition scheme indicated in the additional field may be any of the following: scheme 1, scheme 2a, scheme 2b, scheme 3, scheme 4 or any combination thereof. In some embodiments, there may be an additional field in DCI for indicating the value of symbol/slot offset between repetitions in time domain. It is assumed that the size of the additional field is P₂ bits, where P₂ is a non-negative integer. For example, P₂ may be 0, 1, 2, 3, 4, 5 or 6. In some embodiments, the value of symbol/slot offset between repetitions may be any of the following: 0, 1, 2, 3, 4, 5, 6 or 7. In some embodiments, there may be an additional field in DCI for indicating the value of RB offset between repetitions in frequency domain. It is assumed that the size of the additional field is P₃ bits, where P₃ is a non-negative integer. For example, P₃ may be 0, 1, 2, 3, 4, 5 or 6. In some embodiments, there may be an additional field in DCI for indicating the repetition number. It is assumed that the size of the additional field is P₄ bits, where P₄ is a non-negative integer. For example, P₄ may be 0, 1, 2, 3, 4, 5 or 6. In some embodiments, the repetition number indicated in the additional field may be any the following: 1, 2, 3, 4, 5, 6, 7, 8 or 16. In some embodiments, the value of the additional field may be associated with one predefined value of RB offset configured via RRC and/or MAC signaling. For example, different values of the additional field may be associated with different predefined values of RB offset configured in RRC and/or MAC signaling. In some embodiments, there may be an additional field in DCI for indicating an RV sequence for repetitions. It is assumed that the size of the additional field is P₅ bits, where P₅ is a non-negative integer. For example, P₅ may be 0, 1, 2, 3, 4, 5 or 6. In some embodiments, the additional field may indicate an RV sequence for the repetitions or a cyclic shift of an RV sequence. For example, the RV sequence indicated in the additional field may be any of the following: {0, 3}, {0, 0}, {0, 2}, {0, 2, 3, 1}, {0, 3, 2, 1}, {0, 3, 0, 3} or {0, 0, 0, 0}. In some embodiments, there may be an additional field in DCI for indicating the number of TCI states. It is assumed that the size of the additional field is P₆ bits, where P₆ is a non-negative integer. For example, P₆ may be 0, 1 or 2. In some embodiments, the number of TCI states indicated in the additional field may be any of the following: 1, 2, 3 or 4. In some embodiments, if the number of bits for indicating a configuration from DMRS table G is M and the number of bits for indicating a configuration from DMRS table H is N (where M and N are both positive integers, for example, M may be 4, 5 or 6 and N may be 1, 2, 3 or 4), then the number of bits for indicating a configuration from DMRS table G may equal to a sum of the number of bits for indicating a configuration from DMRS table H and the size of the one or more additional field. That is, N+P₁+P₂+P₃+P₄+P₅+P₆=M. In some embodiments, at least one of P₁, P₂, P₃, P₄, P₅ and P₆ may be equal to zero.

In some embodiments, a list of time domain resource allocation parameters may be configured to the terminal device 130. For example, the parameters may include at least one of a slot offset, a starting symbol of PDSCH/PUSCH and the number of symbols for PDSCH/PUSCH. In addition, the list of time domain resource allocation parameters may be divided into two groups (for example, Group S1 and Group S2). In some embodiments, if a time domain resource allocation parameter within Group S1 is indicated to the terminal device 130, DMRS table A may be used; and if a time domain resource allocation parameters within Group S2 is indicated to the terminal device 130, DMRS table B may be used. DMRS table A and DMRS table B may be different according to the above embodiments.

In some embodiments, if the repetitions of the physical channel are configured for URLLC via a higher layer parameter, there may be one or more fields indicating the number of the repetitions for different schemes in the DCI. For example, there may be one field (also referred to as “field A” in the following) indicating the number of repetitions for Scheme 3, one field (also referred to as “field B” in the following) indicating the number of repetitions for Scheme 4, one field (also referred to as “field C” in the following) indicating the number of repetitions for Scheme 2a and/or one field (also referred to as “field D” in the following) indicating the number of repetitions for Scheme 2b in the DCI. In some embodiments, if the number of repetitions indicated in each of the fields A, B C and/or D is 1, it means that the repetitions of the physical shared channel are disabled. Additionally, if two different TCI states are indicated in the TCI, the two different TCI states may be associated with two different DMRS groups. In some embodiments, at least two of the fields A, B, C and/or D can be encoded jointly. Table 1 shows an example of such embodiments.

TABLE 1
Jointly Indication of Repetition Number and Schemes

| Index | Repetition Number | Details |
|---|---|---|
| 0 | 1 | No repetition. |
| | | If two TCI states are indicated in the DCI, |
| | | each TCI state is associate with one DMRS |
| | | group. |
| 1 | 2 | Scheme 3 (sub-slot based repetitions) |
| 2 | 2 | Scheme 4 (slot based repetitions) |
| 3 | 4 | Scheme 3 |
| 4 | 4 | Scheme 4 |
| 5 | 4 | 2 repetitions based on Scheme 3 |
| | | and 2 repetitions based on Scheme 4 |
| 6 | 8 | Scheme 4 |
| 7 | 8 | 2 repetitions based on Scheme 3 |
| | | and 4 repetitions based on Scheme 4 |
| 8 | 8 | 4 repetitions based on Scheme 3 |
| | | and 2 repetitions based on Scheme 4 |

As shown in Table 1, there are two indications (that is, indication #1 and #2) in Table 1 which indicate that the number of the repetitions is 2. However, indication #1 indicates that the 2 repetitions are based on Scheme 3 (that is, sub-slot based repetition), while indication #2 indicates that the 2 repetitions are based on Scheme 4 (that is, slot based repetition). There are three indications (that is, indications #3-#5) in Table 1 which indicate that the number of the repetitions is 3. However, indication #3 indicates that the 4 repetitions are all based on Scheme 3, indication #4 indicates that the 4 repetitions are all based on Scheme 4 and indication #5 indicates that two of the 4 repetitions are based on Scheme 3 and the other two of the 4 repetitions are based on Scheme 4. It is to be understood that Table 1 is shown only for the purpose of illustration. In some embodiments, a different table which includes some configurations from Table 1 may be used for indication of the number of repetitions to a terminal device. In some embodiments, there may be indications to indicate that the repetitions are based on Scheme 2a or 2b.

In some embodiments, there may be one or more fields indicating the number of repetitions and/or the repetition schemes in the DCI. In some embodiments, there may be one field indicating the number of repetitions R1 for Scheme 3. For example, R1 may be any of 1, 2, 3, 4, 5, 6, 7 and 8. In some embodiments, there may be one field indicating the number of repetition R2 for Scheme 4. For example, R2 may be any of 1, 2, 3, 4, 8 and 16. In some embodiments, there may be one field indicating the number of repetitions R3 for Scheme 2a. For example, R3 may be any of 1, 2, 4, 6, 8 and 16. In some embodiments, there may be one field indicating the number of repetitions R4 for Scheme 2b. For example, R4 may be any of 1, 2, 4, 6, 8 or 16. In some embodiments, the total number of repetitions may be any of the following: R1*R2, R1*R2*R3, R1*R2*R4, R1*R3, R1*R4, R2*R3 or R2*R4. In some embodiments, there may be one field indicating whether Scheme 3 and/or Scheme 4 are applied. In some embodiments, there may be one field indicating the total number of repetitions Rt. For example, the total number of repetitions may be applied to Scheme 3, Scheme 4, Scheme 2a and/or Scheme 2b. For another example, the total number of repetitions may be applied to Scheme 3 and/or Scheme 4. In some embodiments, there may be one field indicating whether Scheme 3 and/or Scheme 4 are applied. For example, the field may need 1 or 2 bits for indication. In some embodiments, there may be one field indicating whether Scheme 2a and/or Scheme 2b are applied. For example, the field may need 1 bit for indication. In some embodiments, if Scheme 2a and/or Scheme 2b are applied, the total number of repetitions may be any of the following: R1*R2*2, R1*2, R2*2 or Rt*2. In some embodiments, if Scheme 2b is not applied, the total number of repetitions may be any of the following: R1*R2, R1, R2 or Rt. In some embodiments, if Scheme 2a and/or Scheme 2b is applied, the total number of repetitions may be any of the following: R1*R2, R1, R2 or Rt. For example, within the total number of repetitions, the number of repetitions based on Scheme 3 may be R1/2. For another example, the number of repetitions based on Scheme 4 may be R2/2. For another example, the number of repetitions based on Scheme 3 and Scheme 4 may be R1*R2/2 or Rt/2.

In some embodiments, there may be a threshold timeDurationForQCL, where the the threshold is set based on capabilities reported by a terminal device (referred in TS 38.306). In some embodiments, for one repetition transmission occasion, if the time offset between the reception of the last symbol of DL DCI and the first or last symbol of the repetition is less than the threshold timeDurationForQCL, the terminal device may assume that the DMRS ports of the repetition are quasi co-located with the RS(s) with respect to the QCL parameter(s) used for PDCCH quasi co-location indication of the CORESET associated with a monitored search space with the lowest CORESET-ID in the latest slot in which one or more CORESETs within the active BWP of the serving cell are monitored by the terminal device. In some embodiments, for one repetition transmission occasion, if the time offset between the reception of the last symbol of DL DCI and the first or last symbol of the repetition is equal to or greater than the threshold timeDurationForQCL, the terminal device may assume that the DMRS ports of the repetition are quasi co-located with the RS(s) in the TCI state with respect to the QCL type parameter(s) given by the indicated TCI state. In some embodiments, the total number of repetitions may be K, for example, where K is a positive integer, and K may be any of 2, 4, 6, 8, 12, 14 or 16. There may be T repetitions, and for each one of the T repetition transmission occasion, the time offset between the reception of the last symbol of DL DCI and the first or last symbol of the repetition may be equal to or greater than the threshold timeDurationForQCL. There may be K-T repetitions, and for each one of the K-T repetition transmission occasion, the time offset between the reception of the last symbol of DL DCI and the first or last symbol of the repetition is less than the threshold timeDurationForQCL. For example, T is a non-negative integer, and 0≤T≤K. In some embodiments, assuming that at least one TCI state is to be used for K repetitions of PDSCH/PUSCH transmission/reception, for the T-K repetitions, the terminal device may assume that the DMRS ports of the repetition are quasi co-located with the RS(s) with respect to the QCL parameter(s) used for PDCCH quasi co-location indication of the CORESET associated with a monitored search space with the lowest CORESET-ID in the latest slot in which one or more CORESETs within the active BWP of the serving cell are monitored by the terminal device. In some embodiments, if two TCI states (TCI A and TCI B) are used for repetitions, for the T repetitions, TCI A will be used for ceil (T/2) or floor (T/2) times, and TCI B will be used for floor (T/2) or ceil (T/2) times. In some embodiments, if three TCI states (TCI A, TCI B and TCI C) are used for repetitions, for the T repetitions, TCI A will be used for T1 times, for example, where T1=ceil (T/3) or T1=floor (T/3); TCI B will be used for T2 times, for example, where T2=ceil (T/3) or T2=floor (T/3); and TCI C will be used for T-T1-T2 times. In some embodiments, if four TCI states (TCI A, TCI B, TCI C and TCI D) are used for repetitions, for the T repetitions, TCI A will be used for T1 times, for example, where T1=ceil (T/4) or T1=floor (T/4); TCI B will be used for T2 times, for example, where T2=ceil (T/4) or T2=floor (T/4); TCI C will be used for T3 times, for example, where T3=ceil (T/4) or T3=floor (T/4); and TCI D will be used for T-T1-T2-T3 times.

In some embodiments, if the physical resource block (PRB) bundling size and/or the pre-coding granularity are configured as “wideband”, and if the terminal device 130 is configured with repetitions and/or FDM based repetitions, the terminal device 130 may be not expected to be scheduled with non-contiguous PRBs. Alternatively, the terminal device 130 may assume to be scheduled with non-contiguous PRBs. In this case, the whole allocated resource may be divided into two groups, and the terminal device 130 may assume that the same pre-coding is applied to each group of the allocated resource.

In some embodiments, if the PRB bundling size and/or the pre-coding granularity are configured as “wideband” and if the terminal device 130 is configured with repetitions and/or FDM based repetitions, the terminal device 130 may be not expected to be scheduled with more than two parts of non-contiguous PRBs. Alternatively, the terminal device 130 may assume to be scheduled with two parts of non-contiguous PRBs.

Alternative, if the PRB bundling size and/or the pre-coding granularity are configured as “wideband” and if the terminal device 130 is configured with repetitions and/or FDM based repetitions, the terminal device 130 can be scheduled with a number of contiguous PRBs and/or the terminal device 130 can be scheduled with two groups of contiguous PRBs (two groups of PRBs, and the PRBs in each group are contiguous), where the two groups of PRBs can be adjacent or not. In some embodiments, if the terminal device 130 is scheduled with a number of contiguous PRBs and the PRBs are divided into two groups, the terminal device 130 may assume that the same pre-coding is applied to each group of allocated resources. In some embodiments, if the terminal device 130 is scheduled with two groups of contiguous PRBs, the terminal device 130 may assume that the same pre-coding is applied to each group of PRBs.

In some embodiments, if the terminal device 130 is configured with repetitions and/or FDM based repetitions, there may be two groups of PRBs to be used for scheduling the terminal device 130, where each group of PRBs may be associated with one TCI state. If the TCI states associated with the two groups of PRBs are different, the terminal device 130 may be not expected to be scheduled by such two groups of PRBs (e.g. group A and group B) that any PRB from group A is located in the same physical resource block group (PRG) as a PRB from group B.

It is assumed that an index of a starting symbol for a repetition in one slot is S and the symbol length of the repetition is L. In some embodiments, for normal Cyclic Prefix (CP), if the number of TCI states exceeds 1 and if 14−(S+L)<L, the terminal device 130 may assume not to be configured with repetitions based on Scheme 3. In some embodiments, for extended CP, if the number of TCI states exceeds 1 and if 12−(S+L)<L, the terminal device 130 may assume not to be configured with repetitions based on Scheme 3.

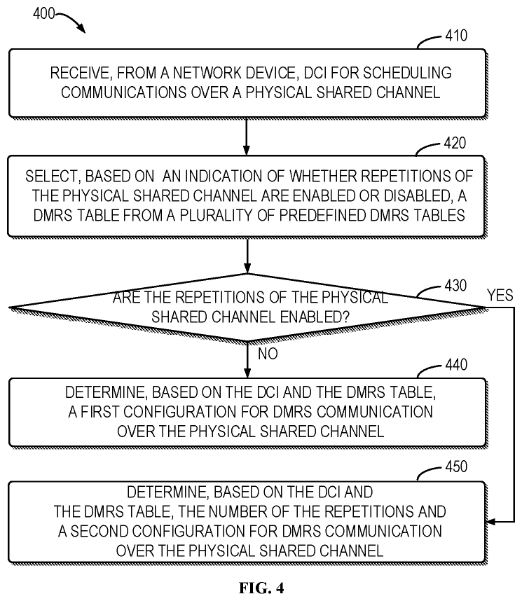

FIG. 4 illustrates an example method 400 in accordance with some embodiments of the present disclosure. In some embodiments, for example, the method 400 may be performed at the terminal device 130 as shown in FIG. 1. It is to be understood that the method 400 may include additional blocks not shown and/or may omit some blocks as shown, and the scope of the present disclosure is not limited in this regard.

At block 410, the terminal device 130 receives, from the network device 110, DCI for scheduling communications over a physical shared channel.

In some embodiments, prior to receiving the DCI, the terminal device 130 may receive, from the network device 110, an indication of whether repetitions of the physical shared channel are enabled or disabled. The indication may be received from the network device 110 via one of the following: RRC signaling; MAC layer signaling; or DCI.

In some embodiments, the physical shared channel may comprise one of the following: a PUSCH or a PDSCH.

At block 420, the terminal device 130 selects, based on the indication of whether the repetitions of the physical shared channel are enabled or disabled, a DMRS table from a plurality of predefined DMRS tables.

In some embodiments, any two of the plurality of predefined DMRS tables may be different from each other in at least one of the following: the number of available DMRS ports; the number of available front-loaded symbols for DMRS; the number of available DMRS groups; and the number of available CWs.

In some embodiments, the plurality of predefined DMRS tables may comprise at least a first DMRS table and a second DMRS table. In response to the repetitions of the physical shared channel being disabled, the terminal device 130 may select the first DMRS table as the DMRS table. In response to the repetitions of the physical shared channel being enabled, the terminal device 130 may select the second DMRS table as the DMRS table.

In some embodiments, the DCI may indicate one or more TCI states to be used for communications over the physical shared channel. The terminal device 130 may select, based on the indication and the number of the TCI states, the DMRS table from the plurality of predefined DMRS tables.

In some embodiments, the plurality of predefined DMRS tables comprise at least a third DMRS table, a fourth DMRS table, a fifth DMRS table and a sixth DMRS table. In response to the one or more TCI states including a single TCI state and the repetitions of the physical shared channel being disabled, the terminal device 130 may select the third DMRS table as the DMRS table. In response to the one or more TCI states including more than one TCI states and the repetitions of the physical shared channel being disabled, the terminal device 130 may select the fourth DMRS table as the DMRS table. In response to the one or more TCI states including a single TCI state and the repetitions of the physical shared channel being enabled, the terminal device 130 may select the fifth DMRS table as the DMRS table. In response to the one or more TCI states including more than one TCI states and the repetitions of the physical shared channel being enabled, the terminal device 130 may select the sixth DMRS table as the DMRS table.

At block 430, the terminal device 130 determines whether the repetitions of the physical shared channel are enabled or disabled.

In response to the repetitions of the physical shared channel being disabled, at block 440, the terminal device 130 determines, based on the DCI and the DMRS table, a first configuration for DMRS communication over the physical shared channel.

In some embodiments, the DMRS table may comprise a plurality of configurations for DMRS communication. In response to the repetitions of the physical shared channel being disabled, the terminal device 130 may determine, from the DCI, a field for indicating one of the plurality of configurations; and determine, from the plurality of configurations, the first configuration indicated by the field.

In some embodiments, in response to the first configuration being determined, the terminal device 130 may communicate, based on the first configuration, a DMRS with the network device 110 over the physical shared channel.

In response to the repetitions of the physical shared channel being enabled, at block 450, the terminal device 130 determines, based on the DCI and the DMRS table, the number of the repetitions and a second configuration for DMRS communication over the repetitions of the physical shared channel.

In some embodiments, the DMRS table may comprise a plurality of configurations for DMRS communication. In response to the repetitions of the physical shared channel being enabled, the terminal device 130 may determine, from the DCI, a first field for indicating the number of the repetitions and a second field for indicating one of the plurality of configurations; determine, based on the first field, the number of the repetitions; and determine, from the plurality of configurations, the second configuration indicated by the second field.

In some embodiments, the DMRS table may comprise a plurality of configurations for DMRS communication and the plurality of configurations may be associated with respective numbers of repetitions of the physical shared channel. In response to the repetitions of the physical shared channel being enabled, the terminal device 130 may determine, from the DCI, a field for indicating one of the plurality of configurations; determine, from the plurality of configurations, the second configuration indicated by the field; and determine the number of the repetitions associated with the second configuration.

In some embodiments, in response to the number of the repetitions and the second configuration being determined, the terminal device 130 may communicate, based on the second configuration, at least one DMRS with the network device over the repetitions of the physical shared channel.

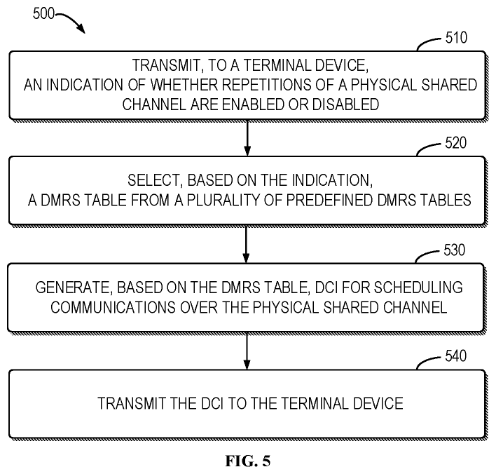

FIG. 5 illustrates an example method 500 in accordance with some embodiments of the present disclosure. In some embodiments, for example, the method 500 may be performed at the network device 110 as shown in FIG. 1. It is to be understood that the method 500 may include additional blocks not shown and/or may omit some blocks as shown, and the scope of the present disclosure is not limited in this regard.

At block 510, the network device 110 transmits, to the terminal device 130, an indication of whether repetitions of a physical shared channel are enabled or disabled.

In some embodiments, the network device 110 may transmit, to the terminal device 130, the indication via one of the following: RRC signaling; MAC layer signaling; or DCI.

In some embodiments, the physical shared channel may comprise one of the following: a PUSCH or a PDSCH.

At block 520, the network device 110 selects, based on the indication, a DMRS table from a plurality of predefined DMRS tables.

In some embodiments, any two of the plurality of predefined DMRS tables may be different from each other in at least one of the following: the number of available DMRS ports; the number of available front-loaded symbols for DMRS; the number of available DMRS groups; and the number of available CWs.

In some embodiments, the plurality of predefined DMRS tables may comprise at least a first DMRS table and a second DMRS table. In response to the repetitions of the physical shared channel being disabled, the network device 110 may select the first DMRS table as the DMRS table. In response to the repetitions of the physical shared channel being enabled, the network device 110 may select the second DMRS table as the DMRS table.

In some embodiments, the network device 110 may determine one or more transmission control indication (TCI) states to be used for communications over the physical shared channel; and select, based on the indication and the number of TCI states, the DMRS table from the plurality of predefined DMRS tables.

In some embodiments, the plurality of predefined DMRS tables may comprise at least a third DMRS table, a fourth DMRS table, a fifth DMRS table and a sixth DMRS table. In response to the one or more TCI states including a single TCI state and the repetitions of the physical shared channel being disabled, the network device 110 may select the third DMRS table as the DMRS table. In response to the one or more TCI states including more than one TCI states and the repetitions of the physical shared channel being disabled, the network device 110 may select the fourth DMRS table as the DMRS table. In response to the one or more TCI states including a single TCI state and the repetitions of the physical shared channel being enabled, the network device 110 may select the fifth DMRS table as the DMRS table. In response to the one or more TCI states including more than one TCI states and the repetitions of the physical shared channel being enabled, the network device 110 may select the sixth DMRS table as the DMRS table.

At block 530, the network device 110 generates, based on the DMRS table, DCI for scheduling communications over the physical shared channel. In response to the repetitions of the physical shared channel being disabled, the generated DCI indicates a first configuration for DMRS communication over the physical shared channel. In response to the repetitions of the physical shared channel being enabled, the generated DCI indicates the number of the repetitions and a second configuration for DMRS communication over the repetitions of the physical shared channel.

In some embodiments, the network device 110 may indicate the one or more TCI states in the DCI.

In some embodiments, the DMRS table may comprise a plurality of configurations for DMRS communication and the DCI may include a field for indicating one of the plurality of configurations. In response to the repetitions of the physical shared channel being disabled, the network device 110 may determine, from the plurality of configurations, the first configuration; and indicate the first configuration in the field.

In some embodiments, the DMRS table may comprise a plurality of configurations for DMRS communication and the DCI may include a first field for indicating the number of the repetitions and a second field for indicating one of the plurality of configurations. In response to the repetitions of the physical shared channel being enabled, the network device 110 may determine the number of the repetitions; indicate the number of the repetitions in the first field; determine, from the plurality of configurations, the second configuration; and indicate the second configuration in the second field.

In some embodiments, the DMRS table may comprise a plurality of configurations for DMRS communication and the plurality of configurations may be associated with respective numbers of repetitions of the physical shared channel. The DCI may include a field for indicating one of the plurality of configurations. In response to the repetitions of the physical shared channel being enabled, the network device 110 may determine the number of the repetitions; determine, from the plurality of configurations, the second configuration associated with the number of the repetitions; and indicate, in the field, the second configuration in association with the number of the repetitions.

At block 540, the network device 110 transmits the DCI to the terminal device 130.

In some embodiments, in response to the repetitions of the physical shared channel being disabled and the DCI being transmitted to the terminal device 130, the network device 110 may communicate, based on the first configuration, a DMRS with the terminal device over the physical shared channel.

In some embodiments, in response to the repetitions of the physical shared channel being enabled and the DCI being transmitted to the terminal device 130, the network device 110 may communicate, based on the second configuration, at least one DMRS with the terminal device over the repetitions of the physical shared channel.

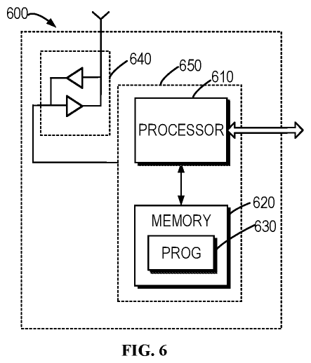

FIG. 6 is a simplified block diagram of a device 600 that is suitable for implementing embodiments of the present disclosure. The device 600 can be considered as a further example implementation of the network device 110, the TRP 120 or the terminal device 130 as shown in FIG. 1. Accordingly, the device 600 can be implemented at or as at least a part of the network device 110, the TRP 120 or the terminal device 130.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 4-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-27. (canceled)

28. A method of communication, comprising:
receiving, at a terminal device and from a network device, Downlink Control Information (DCI) for scheduling communications over a physical shared channel;
in response to receiving an indication of whether repetitions of the physical shared channel are enabled or disabled, selecting, based on the indication, a Demodulation Reference Signal (DMRS) table from a plurality of predefined DMRS tables;
in response to the repetitions of the physical shared channel being disabled, determining, based on the DCI and the DMRS table, a first configuration for DMRS communication over the physical shared channel; and
in response to the repetitions of the physical shared channel being enabled, determining, based on the DCI and the DMRS table, the number of the repetitions and a second configuration for DMRS communication over the repetitions of the physical shared channel.

29. The method of claim 28, further comprising:
receiving, from the network device, the indication via one of the following:
Radio Resource Control (RRC) signaling;
Media Access Control (MAC) layer signaling; or
DCI.

30. The method of claim 28, wherein the plurality of predefined DMRS tables comprise at least a first DMRS table and a second DMRS table, and wherein selecting the DMRS table comprises:
in response to the repetitions of the physical shared channel being disabled, selecting the first DMRS table as the DMRS table; and
in response to the repetitions of the physical shared channel being enabled, selecting, the second DMRS table as the DMRS table.

31. The method of claim 28, wherein the DCI indicates one or more transmission control indication (TCI) states to be used for communications over the physical shared channel, and wherein selecting the DMRS table comprises:
selecting, based on the indication and the number of the TCI states, the DMRS table from the plurality of predefined DMRS tables.

32. The method of claim 31, wherein the plurality of predefined DMRS tables comprise at least a third DMRS table, a fourth DMRS table, a fifth DMRS table and a sixth DMRS table, and wherein selecting the DMRS table comprises:
in response to the one or more TCI states including a single TCI state and the repetitions of the physical shared channel being disabled, selecting the third DMRS table as the DMRS table;
in response to the one or more TCI states including more than one TCI states and the repetitions of the physical shared channel being disabled, selecting the fourth DMRS table as the DMRS table;
in response to the one or more TCI states including a single TCI state and the repetitions of the physical shared channel being enabled, selecting the fifth DMRS table as the DMRS table; and
in response to the one or more TCI states including more than one TCI states and the repetitions of the physical shared channel being enabled, selecting the sixth DMRS table as the DMRS table.

33. The method of claim 28, wherein the DMRS table comprises a plurality of configurations for DMRS communication, and wherein determining the first configuration comprises:
in response to the repetitions of the physical shared channel being disabled,
determining, from the DCI, a field for indicating one of the plurality of configurations; and
determining, from the plurality of configurations, the first configuration indicated by the field.

34. The method of claim 28, wherein the DMRS table comprises a plurality of configurations for DMRS communication, and wherein determining the number of the repetitions and the second configuration comprises:
in response to the repetitions of the physical shared channel being enabled,
determining, from the DCI, a first field for indicating the number of the repetitions and a second field for indicating one of the plurality of configurations;
determining, based on the first field, the number of the repetitions; and
determining, from the plurality of configurations, the second configuration indicated by the second field.

35. The method of claim 28, wherein the DMRS table comprises a plurality of configurations for DMRS communication and the plurality of configurations are associated with respective numbers of repetitions of the physical shared channel, and wherein determining the number of the repetitions and the second configuration comprises:
in response to the repetitions of the physical shared channel being enabled,
determining, from the DCI, a field for indicating one of the plurality of configurations;
determining, from the plurality of configurations, the second configuration indicated by the field; and
determining the number of the repetitions associated with the second configuration.

36. The method of claim 28, wherein any two of the plurality of predefined DMRS tables are different from each other in at least one of the following:
the number of available DMRS ports;
the number of available front-loaded symbols for DMRS;
the number of available DMRS groups; and
the number of available CWs.

37. The method of claim 28, further comprising:
in response to the first configuration being determined,
communicating, based on the first configuration, a DMRS with the network device over the physical shared channel; or
in response to the number of the repetitions and the second configuration being determined,
communicating, based on the second configuration, at least one DMRS with the network device over the repetitions of the physical shared channel.

38. The method of claim 28, wherein the physical shared channel comprises one of the following:
a Physical Uplink Shared Channel (PUSCH); or
a Physical Downlink Shared Channel (PDSCH).

39. A method of communication, comprising:
transmitting, from a network device to a terminal device, an indication of whether repetitions of a physical shared channel are enabled or disabled;
selecting, based on the indication, a Demodulation Reference Signal (DMRS) table from a plurality of predefined DMRS tables;
generating, based on the DMRS table, Downlink Control Information (DCI) for scheduling communications over the physical shared channel, wherein
in response to the repetitions of the physical shared channel being disabled, the DCI indicates a first configuration for DMRS communication over the physical shared channel, and
in response to the repetitions of the physical shared channel being enabled, the DCI indicates the number of the repetitions and a second configuration for DMRS communication over the repetitions of the physical shared channel; and
transmitting the DCI to the terminal device.

40. The method of claim 39, wherein the plurality of predefined DMRS tables comprise at least a first DMRS table and a second DMRS table, and wherein selecting the DMRS table comprises:
in response to the repetitions of the physical shared channel being disabled, selecting the first DMRS table as the DMRS table; and
in response to the repetitions of the physical shared channel being enabled, selecting the second DMRS table as the DMRS table.

41. The method of claim 39, wherein selecting the DMRS table comprises:
determining one or more transmission control indication (TCI) states to be used for communications over the physical shared channel; and
selecting, based on the indication and the number of TCI states, the DMRS table from the plurality of predefined DMRS tables.

42. The method of claim 41, wherein the plurality of predefined DMRS tables comprise at least a third DMRS table, a fourth DMRS table, a fifth DMRS table and a sixth DMRS table, and wherein selecting the DMRS table comprises:
in response to the one or more TCI states including a single TCI state and the repetitions of the physical shared channel being disabled, selecting the third DMRS table as the DMRS table;
in response to the one or more TCI states including more than one TCI states and the repetitions of the physical shared channel being disabled, selecting the fourth DMRS table as the DMRS table;
in response to the one or more TCI states including a single TCI state and the repetitions of the physical shared channel being enabled, selecting the fifth DMRS table as the DMRS table; and
in response to the one or more TCI states including more than one TCI states and the repetitions of the physical shared channel being enabled, selecting the sixth DMRS table as the DMRS table.

43. The method of claim 39, wherein the DMRS table comprises a plurality of configurations for DMRS communication and the DCI includes a field for indicating one of the plurality of configurations, and wherein generating the DCI comprises:
in response to the repetitions of the physical shared channel being disabled,
determining, from the plurality of configurations, the first configuration; and
indicating the first configuration in the field.

44. The method of claim 39, wherein the DMRS table comprises a plurality of configurations for DMRS communication, the DCI includes a first field for indicating the number of the repetitions and a second field for indicating one of the plurality of configurations, and wherein generating the DCI comprises:
in response to the repetitions of the physical shared channel being enabled,
determining the number of the repetitions;
indicating the number of the repetitions in the first field;
determining, from the plurality of configurations, the second configuration; and
indicating the second configuration in the second field.

45. The method of claim 39, wherein the DMRS table comprises a plurality of configurations for DMRS communication, the plurality of configurations are associated with respective numbers of repetitions of the physical shared channel, the DCI includes a field for indicating one of the plurality of configurations, and wherein generating the DCI comprises:
in response to the repetitions of the physical shared channel being enabled,
determining the number of the repetitions;
determining, from the plurality of configurations, the second configuration associated with the number of the repetitions; and
indicating, in the field, the second configuration in association with the number of the repetitions.

46. The method of claim 39, further comprising:
in response to the repetitions of the physical shared channel being disabled and the DCI being transmitted to the terminal device,
communicating, based on the first configuration, a DMRS with the terminal device over the physical shared channel; or
in response to the repetitions of the physical shared channel being enabled and the DCI being transmitted to the terminal device,
communicating, based on the second configuration, at least one DMRS with the terminal device over the repetitions of the physical shared channel.

47. A terminal device comprising:
a processor; and
a memory coupled to the processor and storing instructions thereon, the instructions, when executed by the processor, causing the terminal device to perform a method, the method comprising:
receiving, at the terminal device and from a network device, Downlink Control Information (DCI) for scheduling communications over a physical shared channel;
in response to receiving an indication of whether repetitions of the physical shared channel are enabled or disabled, selecting, based on the indication, a Demodulation Reference Signal (DMRS) table from a plurality of predefined DMRS tables;
in response to the repetitions of the physical shared channel being disabled, determining, based on the DCI and the DMRS table, a first configuration for DMRS communication over the physical shared channel; and
in response to the repetitions of the physical shared channel being enabled, determining, based on the DCI and the DMRS table, the number of the repetitions and a second configuration for DMRS communication over the repetitions of the physical shared channel.
